(19) United States
(12) Patent Application Publication
(10) Pub. No.: US 2025/0080282 A1
(43) Pub. Date: Mar. 6, 2025

(54) METHOD AND DEVICE FOR HYBRID AUTOMATIC REPEAT REQUEST IN INTER-SATELLITE MULTI-CONNECTIVITY ENVIRONMENT

(71) Applicants: Hyundai Motor Company, Seoul (KR); Kia Corporation, Seoul (KR); Inha University Research and Business Foundation, Incheon (KR)

(72) Inventors: Young Kil Suh, Hwaseong, Gyeonggi-do (KR); Kyu Nam Kim, Hwaseong, Gyeonggi-do (KR); Gun Hee Moon, Hwaseong, Gyeonggi-do (KR); Ui Hyun Hong, Hwaseong, Gyeonggi-do (KR); Duk Kyung Kim, Seoul (KR)

(21) Appl. No.: 18/844,013

(22) PCT Filed: Mar. 7, 2023
(86) PCT No.: PCT/KR2023/003125

§ 371 Date: Sep. 4, 2024

(30) Foreign Application Priority Data
Mar. 7, 2022 (KR) 10-2022-0028994

(51) Int. Cl. H04L 1/1822; H04L 5/00; H04W 36/00; H04W 72/21

(52) U.S. Cl. CPC H04L 1/1822; H04L 5/0055; H04W 36/0069; H04W 72/21

(57) ABSTRACT

The present disclosure provides a method and a device for providing a hybrid automatic repeat request (HARQ) in a first non-terrestrial network (NTN)-second NTN multi-connectivity environment. A method of a first base station according to an embodiment of the present disclosure may comprise the steps of: transmitting data to a terminal being in a dual connectivity (DC) state through a first non-terrestrial network (NTN) link using a first satellite connected to the first base station and a second NTN link using a second satellite connected to a second base station; and receiving an uplink channel including first hybrid automatic repeat request (HARQ) feedback information corresponding to data transmitted to the terminal and second HARQ feedback information corresponding to data transmitted through the second NTN link.

### TECHNICAL FIELD

The present disclosure relates to a hybrid automatic repeat request (HARQ) technique, and more particularly, to a HARQ technique in an inter-satellite multi-connectivity environment.

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, technologies aimed at enhancing link reliability and data transmission throughput through multi-connectivity are prominent topics within the 5G NR standardization discussions. Unlike the typical terrestrial network (TN) environment, when multiple links are established in the NTN environment, the latencies of the respective links may vary significantly. Additionally, due to the significantly long latency in the NTN environment, a hybrid automatic repeat request (HARQ) stalling phenomenon may occur, and consequently, increasing the number of HARQ processes has been proposed as a solution. However, the latency issue still needs to be addressed. In particular, the differences in latency according to the satellite altitudes in Low Earth Orbit (LEO), Medium Earth Orbit (MEO), and Geostationary Earth Orbit (GEO) systems are quite significant. Therefore, the approaches used for multi-connectivity with multiple base stations in the conventional TN environment cannot be directly applied to support multi-connectivity in the NTN environment.

### DISCLOSURE

### Technical Problem

The present disclosure is directed to providing a method and an apparatus for HARQ in an inter-satellite multi-connectivity environment.

### Technical Solution

A method of a first base station, according to a first exemplary embodiment of the present disclosure for achieving the above-described objective, may comprise: transmitting data to a terminal through a first non-terrestrial network (NTN) link with a first satellite connected to a first base station and through a second NTN link with a second satellite connected to a second base station, the terminal being in a dual connectivity (DC) state; and receiving at least one uplink channel including first hybrid automatic repeat request (HARQ) feedback information corresponding to the data transmitted to the terminal the first NTN link and second HARQ feedback information corresponding to data transmitted to the terminal through the second NTN link.

Each of the first HARQ feedback information and the second HARQ feedback information may include information indicating acknowledgment (ACK) or negative ACK (NACK) for received data, and the at least one uplink channel may include a first physical uplink control channel (PUCCH1) for transmitting the first HARQ feedback information and a second PUCCH (PUCCH2) for transmitting the second HARQ feedback information.

The PUCCH2 may be received using only a HARQ process preconfigured through a radio resource control (RRC) message by the second base station.

The at least one uplink channel may be an extended PUCCH including an additional field for transmitting at least part of the second HARQ feedback information.

The additional field of the extended PUCCH may include information indicating ACK or NACK for data received through the second NTN link, and may further include at least one of information on a HARQ timing corresponding to the data received through the second NTN link or a HARQ process identifier (ID) within a time span of a codebook corresponding to the data received through the second NTN link.

The method may further comprise: in response to receiving, from a network, the data to be transmitted to the terminal in the DC state, splitting the data to be transmitted to the terminal into data to be transmitted through the first NTN link and data to be transmitted through the second link; and delivering the data to be transmitted through the second NTN link to the second base station.

The method may further comprise: identifying a retransmission request corresponding to data transmitted through the first NTN link and/or a retransmission request for data transmitted through the second link, based on the first HARQ feedback information and the second HARQ feedback information; and in response to identifying that a retransmission corresponding to the data transmitted through the second NTN link is requested, transmitting a retransmission request to the second base station.

The method may further comprise: generating retransmission data using a same scheme as in the second base station of the second NTN link, based on the data transmitted through the second NTN link; and transmitting the generated retransmission data to the terminal when the second HARQ feedback information requests a retransmission corresponding to the data transmitted through the second NTN link.

The retransmission data corresponding to the data transmitted through the second NTN link may be generated based on a same redundancy version (RV) and a same modulation and coding scheme (MCS) as the data transmitted through the second NTN link.

A method of a terminal, according to a first exemplary embodiment of the present disclosure for achieving the above-described objective, may comprise: establishing dual connectivity (DC) with a second non-terrestrial network (NTN) link of a second satellite connected to a second base station while being connected to a first NTN link of a first satellite connected to a first base station, based on a control message received through the first NTN link; receiving data through the first NTN link; receiving data through the second NTN link; generating first hybrid automatic repeat request (HARQ) feedback information corresponding to the data received through the first NTN link; generating second HARQ feedback information corresponding to the data received through the second NTN link; and transmitting the first HARQ feedback information and the second HARQ feedback information through at least one uplink channel of the first NTN link, wherein a difference between a latency of the second NTN link and a latency of the first NTN link is equal to or greater than a preset value.

Each of the first HARQ feedback information and the second HARQ feedback information may include information indicating acknowledgment (ACK) or negative ACK (NACK) for received data, and the at least one uplink channel may include a first physical uplink control channel (PUCCH1) for transmitting the first HARQ feedback information and a second PUCCH (PUCCH2) for transmitting the second HARQ feedback information.

The PUCCH2 may be transmitted using only a HARQ process preconfigured through a radio resource control (RRC) message by the second base station of the second NTN link.

The at least one uplink channel may be an extended PUCCH including an additional field for transmitting at least part of the second HARQ feedback information.

The additional field of the extended PUCCH may include information indicating ACK or NACK for data received through the second NTN link, and may further include at least one of information on a HARQ timing corresponding to the data received through the second NTN link or a HARQ process identifier (ID) within a time span of a codebook corresponding to the data received through the second NTN link.

The method may further comprise: in response to the second HARQ feedback information indicating at least one reception failure for received data, receiving retransmission data through the first NTN link.

The method may further comprise: in response to the second HARQ feedback information indicating at least one reception failure for received data, receiving retransmission data through the second NTN link.

A base station, according to a first exemplary embodiment of the present disclosure for achieving the above-described objective, may comprise at least one processor, and the at least one processor may cause to the base station perform: transmitting data to a terminal through a first non-terrestrial network (NTN) link with a first satellite connected to a first base station and through a second NTN link with a second satellite connected to a second base station, the terminal being in a dual connectivity (DC) state; and receiving at least one uplink channel including first hybrid automatic repeat request (HARQ) feedback information corresponding to the data transmitted to the terminal the first NTN link and second HARQ feedback information corresponding to data transmitted to the terminal through the second NTN link.

Each of the first HARQ feedback information and the second HARQ feedback information may include information indicating acknowledgment (ACK) or negative ACK (NACK) for received data, and the at least one uplink channel may include a first physical uplink control channel (PUCCH1) for transmitting the first HARQ feedback information and a second PUCCH (PUCCH2) for transmitting the second HARQ feedback information.

The at least one uplink channel may be an extended PUCCH including an additional field for transmitting at least part of the second HARQ feedback information.

The at least one processor may further cause to the base station perform: in response to receiving, from a network, the data to be transmitted to the terminal in the DC state, splitting the data to be transmitted to the terminal into data to be transmitted through the first NTN link and data to be transmitted through the second link; delivering the data to be transmitted through the second NTN link to the second base station; identifying a retransmission request corresponding to data transmitted through the first NTN link and/or a retransmission request for data transmitted through the second link, based on the first HARQ feedback information and the second HARQ feedback information; and in response to identifying that a retransmission corresponding to the data transmitted through the second NTN link is requested, transmitting a retransmission request to the second base station.

### Advantageous Effects

According to the present disclosure, in a multi-connectivity environment between satellites, there is an advantage of being able to transmit data smoothly through HARQ operations while reducing latency. Furthermore, the present disclosure provides an advantage of being able to prevent HARQ stalling.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8 is a conceptual diagram for describing network configuration and data transmission according to a DC scheme specified by 3GPP.

FIG. 9A is a diagram illustrating a part of a signal flow for the inter-MN handover with SN change defined in the 3GPP technical specifications.

FIG. 9B is a diagram illustrating the remaining part of the signal flow for the inter-MN handover with SN change defined in the 3GPP technical specifications.

FIG. 10 is a conceptual diagram for describing a time at which a HARQ feedback is transmitted in NR.

FIG. 11A is a conceptual diagram for describing a HARQ timing in TN.

FIG. 11B is a conceptual diagram for describing a HARQ timing in NTN.

FIG. 12A is a conceptual diagram for describing a case of using a semi-static Type 1 HARQ codebook.

FIG. 12B is a conceptual diagram for describing a case of using a dynamic Type 2 HARQ codebook.

FIG. 13 is a conceptual diagram for describing a configuration of DC between NTN-NTN according to an exemplary embodiment of the present disclosure.

FIG. 14 is a conceptual diagram for describing a HARQ feedback timing of a terminal in an NTN-NTN multi-connectivity environment according to an exemplary embodiment of the present disclosure.

FIG. 15A is a conceptual diagram illustrating a case of extending and using a PUCCH field of a TN link with a small latency according to the first exemplary embodiment of the present disclosure.

FIG. 15B is a conceptual diagram illustrating a case of using an additional PUCCH of a first NTN according to the first exemplary embodiment of the present disclosure.

FIG. 16A is a timing diagram for describing a HARQ stalling phenomenon based on reception of PDSCHs from a second satellite of a long link to a terminal and HARQ feedbacks therefor.

FIG. 16B is a timing diagram for describing HARQ feedbacks based on HARQ processes in an NTN-NTN DC environment according to the second exemplary embodiment of the present disclosure.

FIG. 17 is a conceptual diagram illustrating internal hierarchical configuration and connection configuration of base stations according to the second exemplary embodiment of the present disclosure.

FIG. 18 is a conceptual diagram for describing internal hierarchical configuration and connection configuration of base stations according to the third exemplary embodiment of the present disclosure.

### BEST MODE OF THE INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

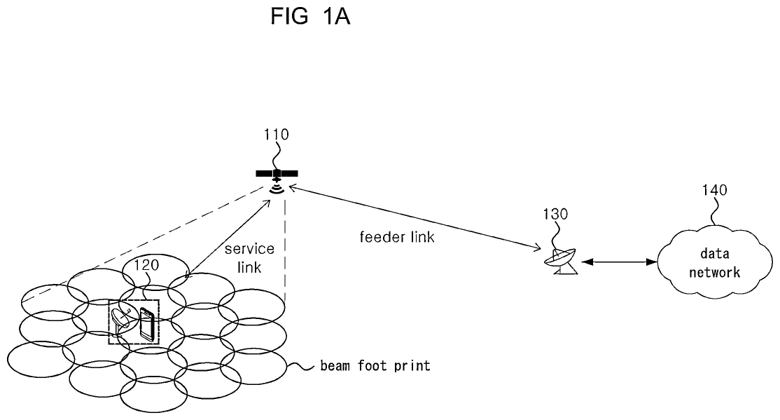

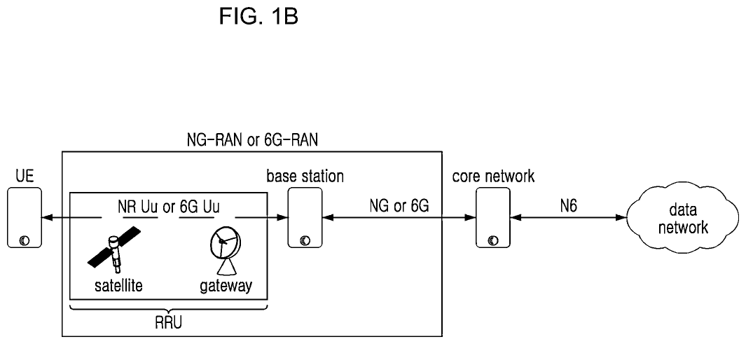

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

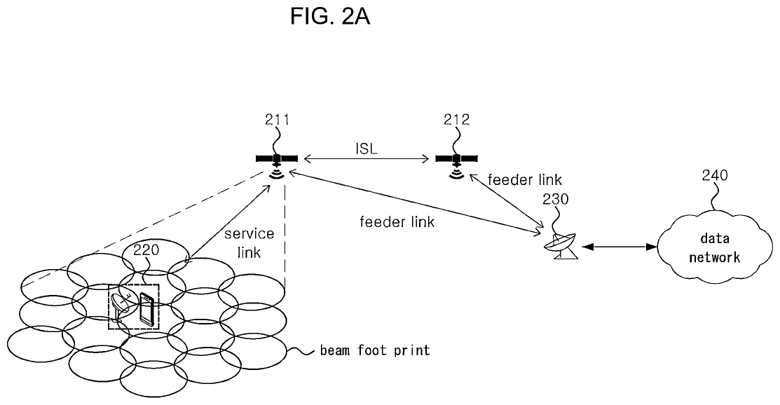

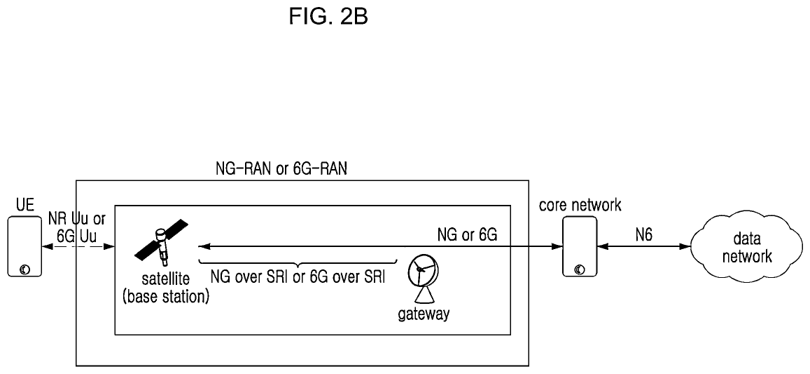

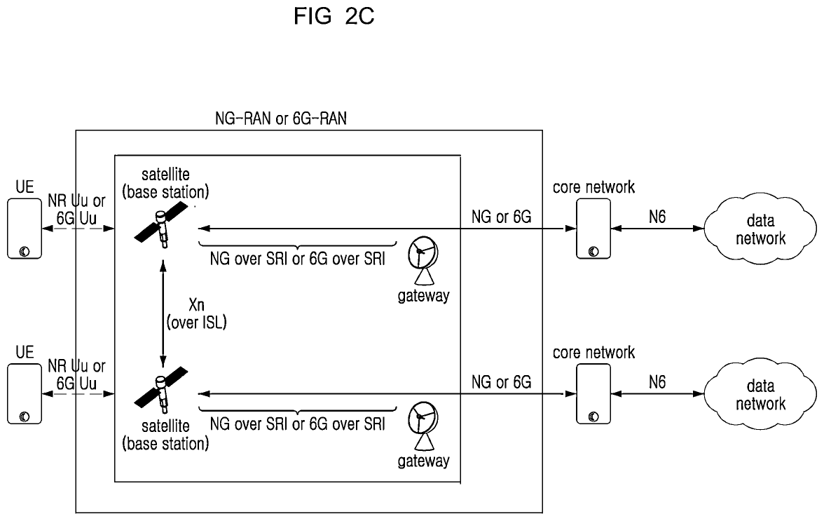

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

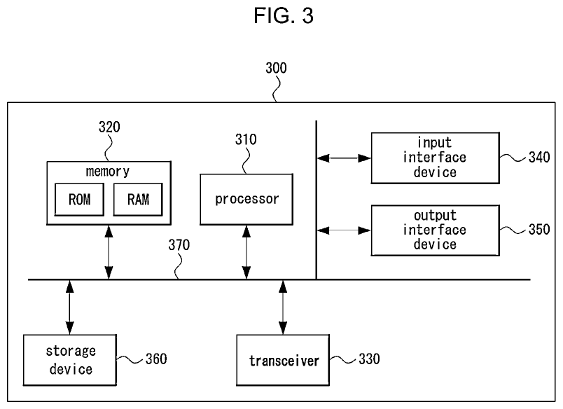

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

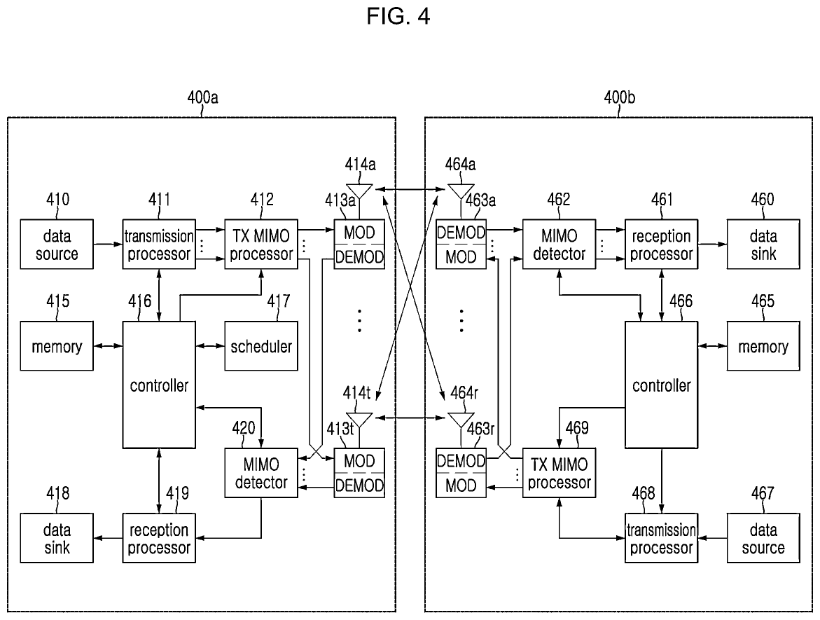

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

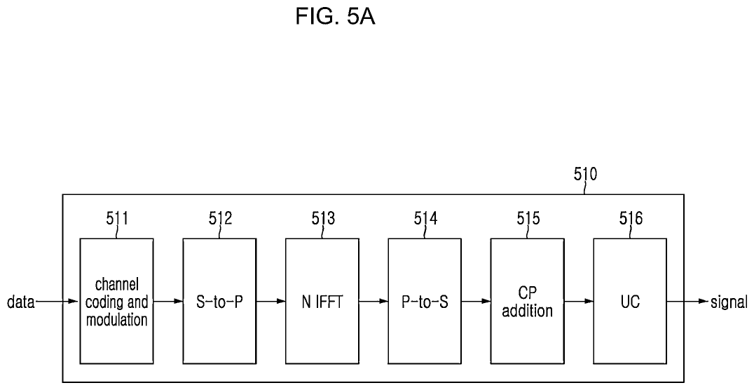

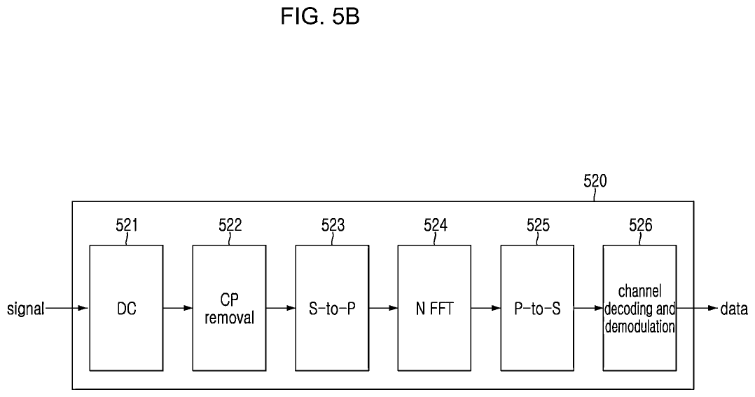

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown in FIG. 1 | NTN shown in FIG. 2 |
|---|---|---|
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’. When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’ Parameters for the NTN reference scenarios defined in Table 1 may be defined as shown in Table 2 below.

TABLE 2

| | Scenarios A and B | Scenarios C and D |
|---|---|---|
| Altitude | 35,786 km | 600 km |
| | | 1,200 km |
| Spectrum | <6 GHz (e.g. 2 GHz) | |
| (service link) | >6 GHz (e.g. DL 20 GHz, UL 30 GHz) | |
| Maximum channel | 30 MHz for band <6 GHz | |
| bandwidth | 1 GHz for band >6 GHz | |
| capability | | |
| (service link) | | |
| Maximum distance | 40,581 km | 1,932 km (altitude |
| between | | of 600 km) |
| satellite and | | 3,131 km (altitude of |
| communication | | 1,200 km) |
| node (e.g. UE) | | |
| at the minimum | | |
| elevation angle | | |
| Maximum round | Scenario A: 541.46 | Scenario C: (transparent |
| trip delay | ms (service and | payload: service and feeder |
| (RTD) (only | feeder links) | links) |
| propagation | Scenario B: | −5.77 ms (altitude of 60 0km) |
| delay) | 270.73 ms | −41.77 ms (altitude of 1,200 |
| | (only service link) | km) |
| | | Scenario D: (regenerative |
| | | payload: only service link) |
| | | −12.89 ms (altitude of 600 |
| | | km) |
| | | −20.89 ms (altitude of 1,200 |
| | | km) |
| Maximum | 10.3 ms | 3.12 ms (altitude of 600 km) |
| differential delay | | 3.18 ms (altitude of 1,200 |
| within a cell | | km) |

| | |
|---|---|
| Service link | NR defined in 3GPP |
| Feeder link | Radio interfaces defined in 3GPP or non-3GPP |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite altitude | 35,786 km | | 600 km | |
| Maximum RTD in a | 541.75 ms | 270.57 ms | 28.41 ms | 12.88 ms |
| radio interface between | (worst case) | | | |
| base station and UE | | | | |
| Minimum RTD in a | 477.14 ms | 238.57 ms | 8 ms | 4 ms |
| radio interface between | | | | |
| base station and UE | | | | |

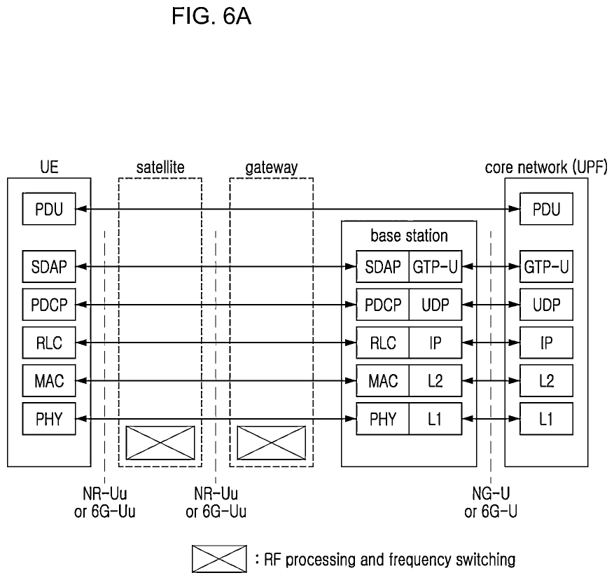

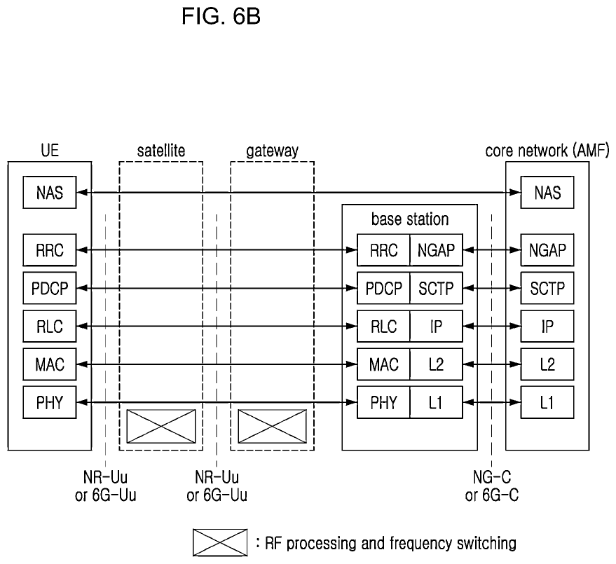

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network.

As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

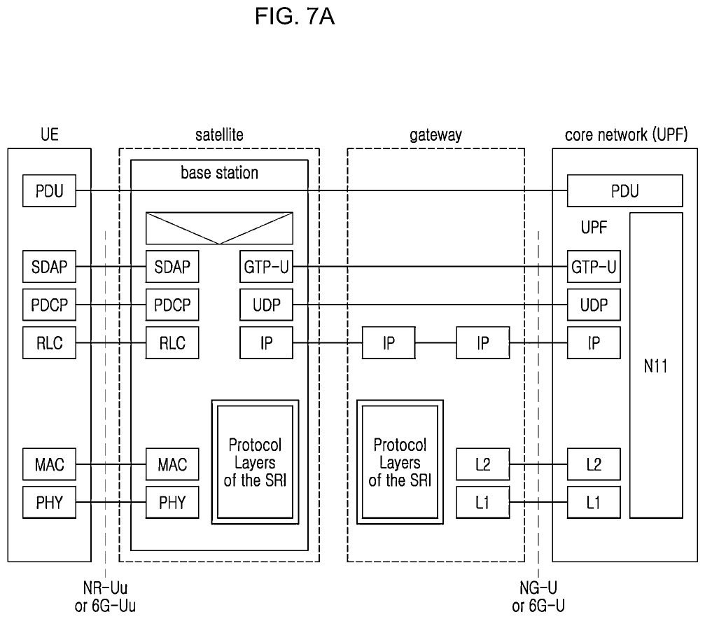

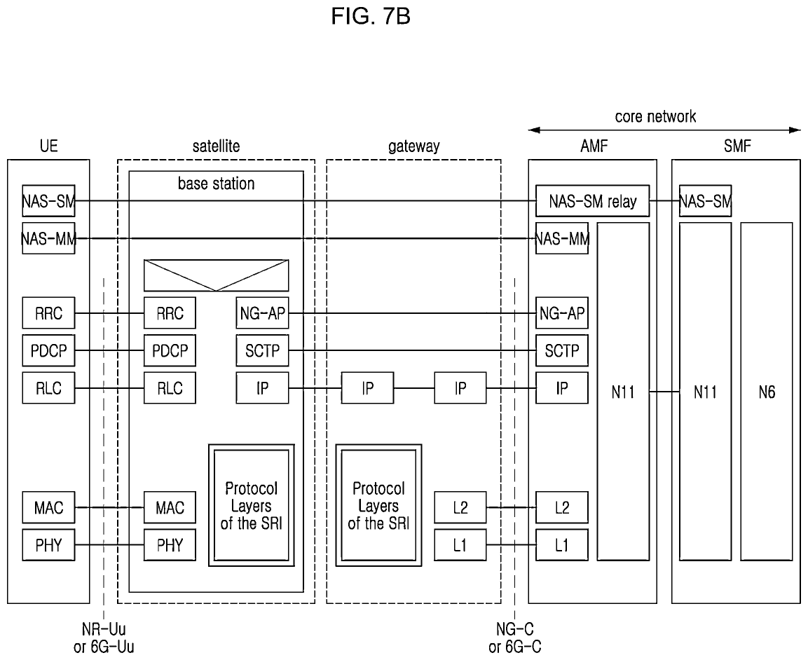

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35,
s40, s45, s50, s55, s60, s120, s180, s240, s900}

| | |
|---|---|
| cellSpecifickoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

Meanwhile, technologies aimed at enhancing link reliability and data transmission throughput through multi-connectivity are prominent topics within the 5G NR standardization discussions. Unlike the typical terrestrial network (TN) environment, when multiple links are established in the NTN environment, the latencies of the respective links may vary significantly. Additionally, due to the significantly long latency in the NTN environment, a hybrid automatic repeat request (HARQ) stalling phenomenon may occur, and consequently, increasing the number of HARQ processes has been proposed as a solution. However, the latency issue still needs to be addressed. In particular, the differences in latency according to the satellite altitudes in Low Earth Orbit (LEO), Medium Earth Orbit (MEO), and Geostationary Earth Orbit (GEO) systems are quite significant. Therefore, the approaches used for multi-connectivity with multiple base stations in the conventional TN environment cannot be directly applied to support multi-connectivity in the NTN environment.

Therefore, in the present disclosure described below, more efficient HARQ operation methods in a multi-connectivity environment between NTN satellites will be described. In particular, the present disclosure will describe more efficient HARQ operation methods in a multi-connectivity NTN environment of bent-pipe satellites. The bent-pipe satellite is a transparent satellite described above, and may be a satellite that only performs a role of amplifying and relaying signals.

First, discussions related to multi-connectivity in NTN at the 3GPP standardization meeting are as follows.

The matters discussed at the 3GPP standardization meeting #Rel 18 NTN WIP are as follows.
At the 3GPP standardization meeting for Rel 18 NTN, the needs for research on multi-connectivity have been raised by several companies, including Thales, Samsung, FGI, Rakuten, LGE, Xiaomi, and Hughes.
Proposals from Samsung (RWS-210186)
A satellite offering continuous connection can manage mobility. For example, a GEO satellite may become an anchor node.
Before construction of a LEO constellation, a very limited number of LEO satellites can provide a better link for data transmission.
FGI and APT proposed that TN/NTN connectivity should be supported in Release 18.
LGE proposed various multi-connectivity NTN scenarios such as LEO+LEO, GEO+LEO, and TN+NTN.
CATT proposed to consider TN/NTN or LEO/GEO connectivity.

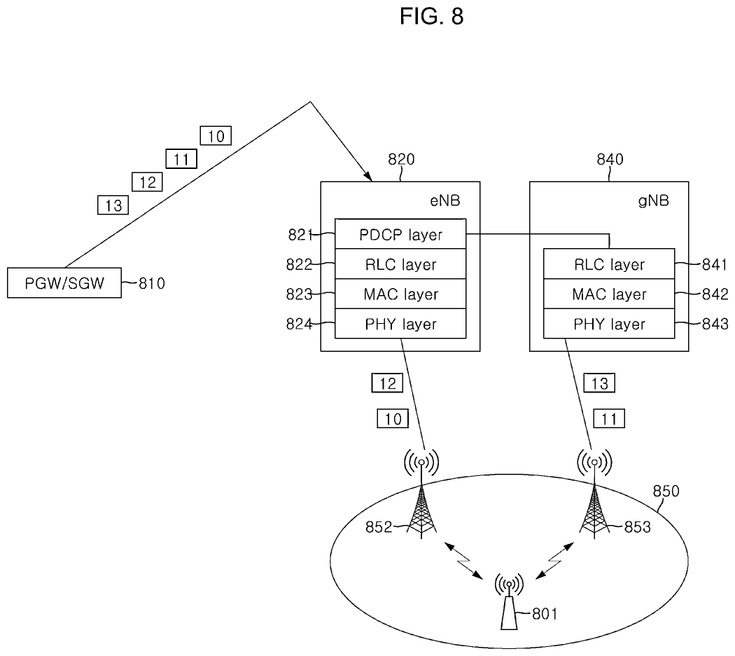

Meanwhile, the 3GPP technical specifications provide carrier aggregation (CA) and dual connectivity (DC) schemes. Specifically, the 5G NR technical specifications support CA and DC techniques. Both techniques facilitate reception of signals through multiple links. In this case, the DC technique is a special case of multi-connectivity (MC) and may correspond to a case of receiving signals through two links. In case of the MC, there may be a master cell group (MCG) and a secondary cell group (SCG). The DC scheme, which is a special example of the MC scheme, will be described with reference to FIG. 8.

FIG. 8 is a conceptual diagram for describing network configuration and data transmission according to a DC scheme specified by 3GPP.

As shown in FIG. 8, a terminal 801, a first base station 820, a second base station 840, and a gateway 810 are illustrated.

The gateway 810 may be located at an end of a core network that transmits data to the terminal 801, and may be a packet data network (PDN) gateway (PGW) and/or serving gateway (SGW), as illustrated in FIG. 8. The SGW may be a node that routes all user data transmitted to or received from the terminal 801, and may serve as an anchor for the terminal 801 that communicates using the LTE or 3GPP technology. The PGW may perform a role of communicating between the terminal 801 and an external network of the 3GPP core network, such as an Internet or another private network. In the following description, the PGW/SWG will be described as the gateway 810.

In addition, the base station 820 is exemplified as an eNB, which is an LTE or LTE-A base station. However, in case of a 5G gNB, it may have the same configuration as that of FIG. 8A. The base station 820 may provide wireless communications with the terminal 801 according to the 3GPP standard protocols. For example, if the base station 820 conforms to the LTE scheme, it may communicate with the terminal 801 based on LTE standards, and if the base station 820 conforms to the 5G scheme, it may communicate with the terminal 801 based on 5G standards.

In addition, the base station 820 may internally include a packet data convergence protocol (PDCP) layer 821, a radio link control (RLC) layer 822, a medium access control (MAC) layer 823, and a physical (PHY) layer 824.

The PDCP layer 821 may be responsible for an interface between an external network, for example, a network other than the 3GPP network, and an internal network, for example, the 3GPP network. The PDCP layer 821 may reduce the number of information bits transmitted through an air interface of the 3GPP network for data received from the external network, and perform IP header compression on user plane data packets to improve transmission efficiency.

The RLC layer 822 may be a layer for automatic repeat request (ARQ), and may deliver the data to a lower or upper layer after performing classification and/or reordering on the data.

The MAC layer 823 may perform HARQ control, multiplexing/demultiplexing, logical channel priority control, and the like for data communicated with the terminal 801. Therefore, the MAC layer 823 may control initial transmission, retransmission, etc. of data transmitted based on a HARQ scheme.

The physical layer 824 may perform processing to transmit data received from the upper layer to the terminal 801. The physical layer 824 may transmit the data received from the upper layer to the terminal through predetermined radio channels (e.g. PDSCH or PDCCH) by up-converting the data into signals in a transmission band, and amplifying the signals.

In addition, the PDCP layer 821 of the first base station 820 may split the data blocks 10, 11, 12, and 13 into data blocks to be transmitted from the first base station 820 and data blocks to be transmitted through the second base station 840 in the PDCP layer 821. The base station that performs division of data to be transmitted to the terminal 801 as described above may be referred to as a master node (MN). The master node may perform control and data division for data transmission to the terminal 801. In addition, the master node may include and/or manage a master cell group (MCG) 852.

The second base station 840 differs from the first base station 820 in that it is a base station (gNB) based on the 5G NR standards, and is illustrated in a form that does not include the PDCP layer. The reason why the PDCP layer is not included in the second base station 840 is that the configuration for DC communication illustrates a scenario where the second base station 840 operates as a secondary node (SN). In other words, when the second base station 840 communicates with the terminal 801 alone and/or when the second base station 840 operates as an MN, the PDCP layer may be included in the second base station 840.

The second base station 840 may include an RLC layer 841, a MAC layer 842, and a physical layer 843. In addition, the RLC layer 841, MAC layer 842, and physical layer 843 of the second base station 840 may perform the same or similar operations as those of the RLC layer 822, MAC layer 823, and physical layer 824 of the first base station 820, respectively. However, the only difference is that the second base station 840 conforms to the NR communication protocol, while the first base station 820 conforms to the LTE-A communication protocol. In addition, the secondary node may include and/or manage a secondary cell group (SCG).

In FIG. 8, a communication coverage 850 may be an overlapping region between communication coverages of the first base station 820 and the second base station 840. Since the first base station 820 is a base station conforming to the LTE-A protocol, it may use a lower frequency band than the second base station 840. Therefore, the first base station 820 may have a wider communication coverage than the second base station 840. In other words, the second base station 840 may have a narrower communication coverage than the first base station 820.

FIG. 8 illustrates a case where the terminal 801 receives data from the respective base stations 820 and 840 based on the DC scheme. Therefore, the communication coverage 850 may be a region where a communication coverage (not shown in FIG. 8) by the first base station 820 and a communication coverage (not shown in FIG. 8) by the second base station 820 overlap.

Hereinafter, a scheme in which downlink data is transmitted in DC communication will be described with reference to FIG. 8. The gateway 810 may deliver data blocks 10, 11, 12, and 13 to be transmitted to the terminal 801 to the first base station 820. Here, the reference numerals 10, 11, 12, and 13 of the data blocks may indicate an order of the data blocks. The PDCP layer 821 of the first base station 820 may split the received data blocks into data blocks to be transmitted from the first base station 820 and data blocks to be transmitted from the second base station 840. According to the example of FIG. 8, the PDCP layer 821 of the first base station 820 may determine the first base station 820 to transmit the data blocks 10 and 12 among the received data blocks 10, 11, 12 and 13, and determine the second base station 840 to transmit the data blocks 11 and 13 among the same data blocks.

Accordingly, the PDCP layer 821 of the first base station 820 may transmit the data blocks 10 and 12 to the terminal located in the cell 852 of the first base station through the RLC layer 822, MAC layer 823, and physical layer 824. In addition, the PDCP layer 821 of the first base station 820 may deliver the data blocks 11 and 13 to the RLC layer 822 of the second base station. Then, the RLC layer 822, MAC layer 823, and physical layer 824 of the second base station 840 may transmit the data blocks 11 and 13 received from the first base station 820 to the terminal 801 through the cell 853 of the second base station 840.

As described above, according to the DC scheme, user traffic is split at the PDCP layer of the base station, which is the master node. In a typical TN environment, the CA technique may be applied when two base stations are co-located or when a backhaul between two base stations is ideal, and the DC technique may be applied when a backhaul between two base stations is not ideal.

The DC scheme illustrated in FIG. 8 may be utilized to enhance data transmission throughput. When enhancing data transmission throughput, the master node may divide traffic, resulting in potentially different data being transmitted from each base station. On the contrary, PDCP duplication may serve as a means to improve data transmission reliability in the DC scheme. In essence, PDCP duplication may enable both the master node and secondary node to transmit identical data to the terminal.

Hereinafter, operations in a multi-connectivity environment will be described. The various operations required in the multi-connectivity environment are described in the 3GPP TS 37.340. In the multi-connectivity environment, the base stations may be classified into a master node (MN) and a secondary node (SN), and the two nodes may be connected through an Xn interface.

As the terminal moves, there may be a need to change master/secondary nodes, akin to a handover process. Specifically, TS 37.340 outlines operations such as secondary node addition, secondary node release, secondary node change, inter-master node (MN) handover with or without secondary node change, and similar procedures.

The secondary node addition operation may be initiated by the MN and may be an operation for adding an SN. The secondary node release operation may be initiated by the MN or SN and may be an operation for releasing an SN. The secondary node change operation may be initiated by the MN or SN, and may be an operation of transferring UE context of a terminal from a source SN to a target SN, and changing SCG configuration of the terminal. The inter-MN handover may move UE context of a terminal from a source MN to a target MN, and at this time, the SN may be maintained or changed.

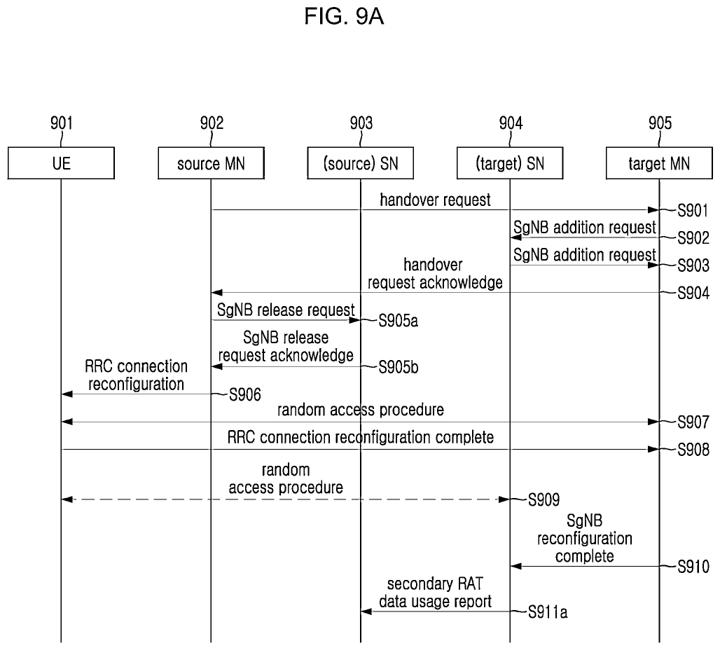

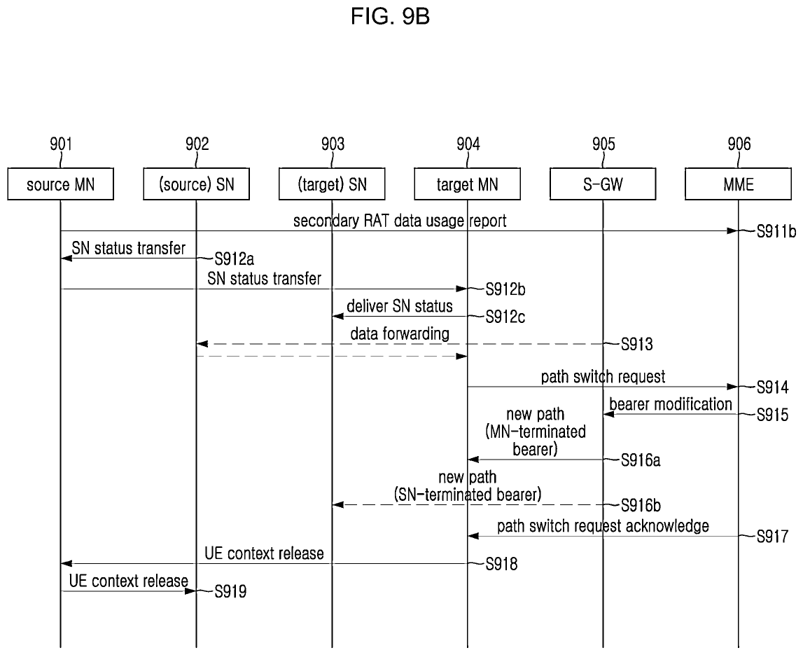

FIG. 9A is a diagram illustrating a part of a signal flow for the inter-MN handover with SN change defined in the 3GPP technical specifications, and FIG. 9B is a diagram illustrating the remaining part of the signal flow for the inter-MN handover with SN change defined in the 3GPP technical specifications.

FIGS. 9A and 9B may correspond to sequential procedures. In other words, the procedure of FIG. 9B may be performed after the procedure of FIG. 9A. In addition, the procedures of FIGS. 9A and 9B may be omitted or not performed in certain cases. In addition, some components in FIG. 9A or 9B are not illustrated in the other drawing. This is due to limitations in the drawings, and they should be understood with overall reference to FIGS. 9A and 9B.

As shown in FIGS. 9A and 9B, operations of a UE 901, a source master node (MN) 902, a (source) secondary node (SN) 903, a (target) SN 904, a target MN 905, a serving gateway (S-GW) 906, and a mobility management entity (MME) 907 are illustrated. The UE 901 may correspond to the terminal described above, and will be described using a form described in the 3GPP technical specifications.

In step S901, the source MN 902 may start a handover procedure by initiating an X2 handover preparation procedure including configuration of a master cell group (MCG) and secondary cell group (SCG). The source MN 902 may transmit a handover request message to the target MN 905 in step S901. The handover request message may include a (source) SN UE X2AP ID, SN ID, and UE context.

If the target MN 905 decides to maintain the UE context in the SN in step S902, the target MN 905 may transmit a SgNB addition request message including the SN UE X2AP ID as a reference to the UE context in an SN that was established by the source MN 902. If the target MN 905 decides to change an SN allowing a delta configuration, the target MN 905 may transmit a SgNB addition request message including the UE context of the SN that was established by the source MN 902 to the target SN 904. Otherwise, the target MN 905 may transmit a SgNB addition request to the target SN 904, including the SN UE X2AP ID or the UE context of the source SN 903 that was established by the source MN 902.

In step S903, the (target) SN 904 may transmit a SgNB addition request acknowledge message to the target MN 905. The (target) SN 904 may include an indication of a full RRC configuration or a delta RRC configuration.

In step S904, the target MN 905 may include a handover request acknowledge message in a transparent container to be transmitted to the UE 901 as an RRC message in order to perform handover, and provide a forwarding address to the source MN 902. If the target MN 905 and the target SN 904 decide to maintain the UE context in the SN in steps S902 and S903, the target MN 905 may inform the source MN 902 that the UE context is maintained in the SN.

In step S905a, the source MN 902 may transmit a SgNB release request message including a cause indicating MCG mobility to the (source) SN 903.

In step S905b, the (source) SN 903 may approve the release request and transmit a release request acknowledge message to the source MN 902. When the source MN 902 receives the indication from the target MN 905, it informs the (source) SN 903 that the UE context of the SN is maintained. If there is the indication to maintain the UE context stored in the SN, the source SN 903 may maintain the UE context.

In step S906, the source MN 902 may trigger the UE 901 to apply a new configuration. In response, the source MN 902 may transmit an RRC connection reconfiguration (RRCConnectionReconfiguration) message to the UE 901.

In step S907, the UE 901 may synchronize with the target MN 905 through a random access procedure.

In step S908, the UE 901 may respond to the target MN 905 with an RRC connection reconfiguration complete (RRCConnectionReconfigurationComplete) message.

In step S909, if a bearer requiring SCG radio resources is configured, the UE 901 may synchronize with the (target) SN 904 through a random access procedure.

When the RRC connection reconfiguration procedure is successful, in step S910, the target MN 905 may notify the (target) SN 904 through a SgNB reconfiguration complete message.

In step S911a, the (source) SN 903 may transmit a secondary RAT data usage report message to the source MN 902, and the secondary RAT data usage report message may include information on a volume of data transmitted to the UE 901 or received from the UE 901 through an NR radio interface for a relevant E-RAB.

In step S911b, the source MN 902 may transmit a secondary RAT report message to the MME 907 to provide information on used NR resources.

In step S912a, the (source) SN 902 may inform a status of the SN to the source MN 902 through an SN status transfer message.

In step S912b, for a bearer using RLC AM, the source MN 902, if necessary, may transmit an SN status transfer message including the SN status received from the (source) SN 902 to the target MN 904. The target MN 904 may deliver the SN status to the (target) SN 904 if necessary (not shown in the drawing).

When applied in step S913, data forwarding may be performed from the source side. If the SN is maintained, data forwarding for SN-terminated bearers maintained in the SN may be omitted.

In steps S914-S917, the target MN may start an S1 path switching procedure. Specifically, in step S914, the target MN 905 may transmit a path switch request message to the MME 907. In step S915, the MME 907 may perform bearer modification with the S-GW 906. In step S916a, the S-GW 906 may transmit information on a new path (MN-terminated bearer) to the target MN 905. In addition, in step S916b, the target MN 905 may transmit information on a new path (SN-terminated bearer) to the (target) SN 904. Thereafter, in step S917, the MME 907 may transmit a path switch request acknowledge message to the (target) SN 904.

In step S918, the target MN 905 may start a UE context release procedure with the source MN 902. In other words, the target MN 905 may transmit a UE context release message to the source MN 902.

In step S919, the source MN 902 may deliver the UE context release message to the (source) SN 903. Upon receiving the UE context release message in step S919, the (source) SN 903 may release control plane (C-plane) related resources related to the UE context destined for the source MN. Meanwhile, all data forwarding in progress may continue. The (source) SN 903 may not release the UE context related to the target MN when the UE context kept indication is included in the SgNB release request message in step S905.

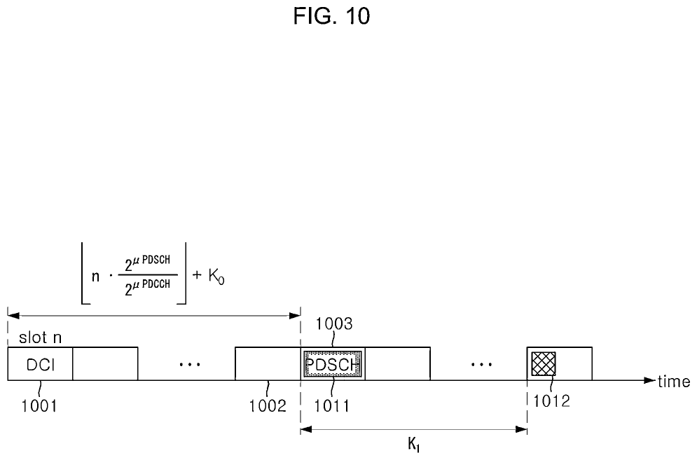

FIG. 10 is a conceptual diagram for describing a time at which a HARQ feedback is transmitted in NR.

As shown in FIG. 10, downlink control information (DCI) included in a physical downlink control channel (PDCCH) is transmitted in a slot n 1001. The DCI may indicate the slot 1011 in which a PDSCH 1003 is transmitted. Therefore, data may be transmitted in the slot 1011 corresponding to a time after a certain number of slots from the slot 1001 in which the DCI is transmitted. In other words, there may be a certain time delay from the slot n 1001 where the DCI is transmitted to a slot 1002 immediately before the PDSCH 1003 is transmitted. This delay may be calculated as shown in Equation 1 below.

$$⌊ n \cdot \frac{{2}^{{μ}_{PDSCH}}}{{2}^{{μ}_{PDCCH}}} ⌋ + {K}_{0} \qquad [ Equation 1 ]$$

Equation 1 is described in the 3GPP NR technical specification TS 38.214. n indicates a slot including the scheduling DCI, μ_{PDSCH} indicates a subcarrier spacing (SCS) of the PDSCH, and 2^{μ}^{_{PDCCH}} indicates a SCS of the PDCCH. As described above, K₀ may be a time delay between the DCI slot and the PDSCH slot.

In addition, in FIG. 10, the PDSCH 1003 may be transmitted in the entire time-frequency region of the one slot 1011, or may be transmitted only in a portion of the time-frequency region within the slot. Therefore, it should be noted that in FIG. 10, the PDSCH 1003 and the slot 1011 transmitting the PDSCH 1003 are assigned different reference numerals.

A physical uplink control channel (PUCCH) may be transmitted in a slot 912 after slots corresponding to K₁ that is a certain offset from the slot 911 in which the PDSCH 903 is transmitted. The PUCCH may include uplink control information (UCI), and HARQ feedback information for the PDSCH 903, that is, ACK/NACK information, may be transmitted as being included within the UCI.

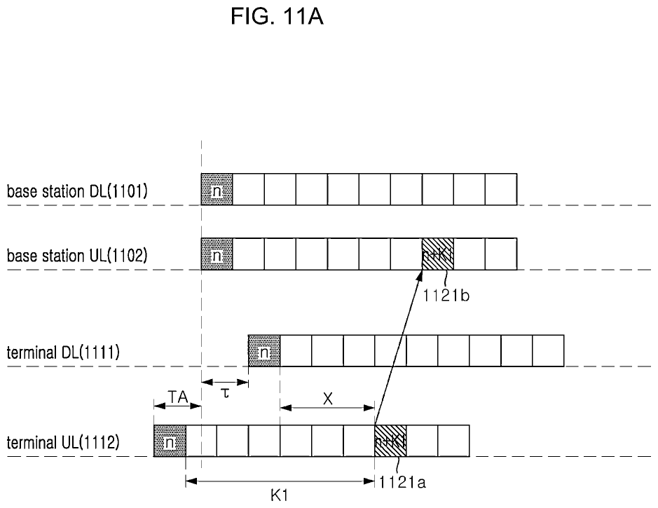

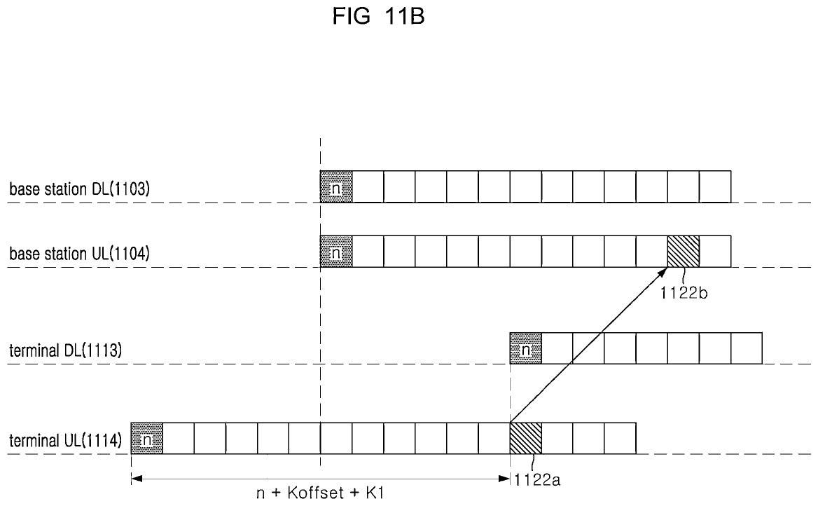

In addition, communication may be performed between the base station and the terminal or between the TRP and the terminal at a certain distance. Therefore, signals transmitted between the base station and the terminal or between the TRP and the terminal may be delayed by the distance. This delay may be equally applied to the HARQ feedback described above. This will be described with reference to FIGS. 11A and 11B.

FIG. 11A is a conceptual diagram for describing a HARQ timing in TN, and FIG. 11B is a conceptual diagram for describing a HARQ timing in NTN.

As shown in FIG. 11A, a downlink (DL) 1101 of a base station (gNB) and an uplink (UL) 1102 of the base station may be aligned in time. That is, the n-th slot of the DL and the n-th slot of the UL may be aligned at the same time.

The base station may transmit data (or packet or signal) to a terminal on a PDSCH using the DL 1101. Then, as illustrated in FIG. 11A, the terminal may receive the n-th slot at a time delayed by a time delay t based on a distance between the base station and the terminal.

Meanwhile, uplink transmission needs to be performed by applying a timing advance (TA) value based on the distance between the terminal and the base station. Therefore, the terminal needs to perform transmission of data (or packet or signal) to the base station on the UL 1112 earlier by the TA. Only when the terminal transmits the data at a time point earlier by the TA in this manner, the base station can receive the data in a state where the base station DL 1101 and the base station UL 1102 are temporally aligned as illustrated in FIG. 11A.

In FIG. 11A, K₁ is a time interval between the PDSCH slot and the slot transmitting UCI described in FIG. 10. In addition, since the terminal needs to actually transmit data (or HARQ feedback) in advance based on the TA value, a slot 1121a in which the terminal needs to transmit actual UCI may have a delay corresponding to X from the DL 1111 of the terminal as illustrated in FIG. 11A. The value of X may be determined based on the distance between the base station and the terminal and a speed at which the terminal processes the data.

FIG. 11A described above illustrates the HARQ timing in TN as an example. A case of NTN will be described with reference to FIG. 11B.

The base station in FIG. 11B may be a satellite. As another example, the base station may collectively refer to a connection ‘satellite-gateway-base station’ or a connection ‘base station-gateway-satellite’. Accordingly, in FIG. 11B, a latency between the base station DL 1103 and its corresponding terminal DL 1113 may be a latency in a path of ‘base station→gateway→satellite→terminal’, and a latency between the terminal UL 1114 and its corresponding base station UL 1104 may be a latency in a path of ‘terminal→satellite→gateway→base station’. Hereinafter, for convenience of description, the base station DL 1103, base station UL 1104, terminal DL 1113, and terminal UL 1114 will be described, with only the reference numerals different from those in FIG. 11A, as illustrated in FIG. 11B.

The DL 1103 of the base station and the UL 1104 of the base station may be aligned in time as described in FIG. 11A. For example, the n-th slot of the DL and the n-th slot of the UL may be aligned at the same time.

The base station may transmit data (or packet or signal) to the terminal on a PDSCH using the DL 1103. Then, a time delay may occur also in the case of FIG. 11B based on a distance between the base station and the terminal. When comparing FIG. 11B with FIG. 11A, it can be seen that a DL 1013 of the terminal has a significantly longer delay time compared to FIG. 10A.

In addition, the terminal UL 1114 needs to be time-aligned with the base station UL 1104, as described in FIG. 11A. Therefore, when the terminal transmits the n-th slot through the terminal UL 1114, it needs to transmit significantly earlier by more slots (a longer time) compared to FIG. 11A. This phenomenon arises because the path delay in NTN is longer than in TN. Additionally, apart from data transmission, the slot 1122a, in which the terminal transmits UCI including a feedback after receiving data in the n-th slot through the base station DL 1103, also needs to be significantly earlier compared to the scenario depicted in FIG. 11A.

Therefore, in case of the terminal communicating with the satellite, it may be difficult to define the delay between the PDSCH slot and the slot transmitting UCI using only the factor of K₁ described above. Therefore, to compensate for this, K_{offset} may be additionally considered, and the HARQ timing is defined as in Equation 2 below.

$$n + {K}_{offset} + {K}_{1} \qquad [ Equation 2 ]$$

In Equation 2, n may indicate the n-th slot, K₁ may indicate a delay between the PDSCH slot and the slot transmitting UCI, and K_{offset} may be a value to compensate for the delay depending on the distance between the terminal and the satellite.

In line with the descriptions provided in FIGS. 11A and 11B, the timing between data transmission and HARQ response is predefined in the 3GPP technical specifications. However, in the FDD scheme, which is suitable for the NTN environment, this timing is set as 3 milliseconds, whereas in the LTE TDD scheme, it varies depending on the uplink/downlink configuration, presenting a somewhat complex scenario. Conversely, in the 5G NR system, the timing between data transmission and HARQ response is flexibly determined through a combination of DCI and RRC signaling. To elaborate, an RRC message configures a table containing multiple possible timings between data transmission and HARQ response, and DCI may specify an index of an entry in the table using a 3-bit pointer.

### [5G NR PUCCH and HARQ]

Hereafter, a PUCCH and HARQ according to the 5G NR technical specifications will be described.

A PUCCH may be used to transmit UCI as previously described. UCI may include HARQ feedback, channel state information (CSI), scheduling request (SR), and/or the like. Components included in a PUCCH will be described briefly.

CSI or a CSI report may be similar to those used in LTE. However, they may differ from those of LTE in that they are slightly more complex. As in LTE, NR has several components of CSI. The components may include channel quality information (CQI), precoding matrix indicator (PMI), channel state information reference signal (CSI-RS) resource Indicator (CRI), synchronization signal/physical broadcast channel block (SS/PBCH block) resource indicator (SSBRI), layer indicator (LI), rank indicator (RI), and the like.

SR may be a physical layer message that requests an uplink grant (UL Grant) from the network so that the terminal can transmit a PUSCH.

Hereinafter, a HARQ feedback will be described.

A HARQ feedback is allocated 1 bit per a transport block (TB). From the terminal's perspective, HARQ ACK/NACK feedbacks for reception of multiple PDSCHs may be transmitted on one PUSCH/PUCCH. A timing between a PDSCH reception and a corresponding ACK/NACK may be specified by DCI. A corresponding DCI field may be a PDSCH-to-HARQ_feedback timing indicator, and its value may be selected from a set configured by a dl-DataToUL-ACK information element (IE).

In addition, code block group (CBG)-based HARQ feedback is supported in the NR standard. In CBG-based HARQ feedback, 1 bit of feedback is supported for each CBG. One transport block (TB) may have multiple CBGs, and a codebook may be a bit sequence constructed using ACK/NACK feedbacks for multiple PDSCHs received during a time window indicated by DCI. The CBG-based HARQ scheme may be used for carrier aggregation (CA), spatial multiplexing, and dual connectivity.

The CBG-based HARQ feedback scheme supports two types of HARQ codebook. A Type 1 codebook supported by the CGB-based HARQ codebook scheme may be a fixed-size codebook according to a semi-static scheme. The Type 1 codebook is simple to use because it has a fixed size, but there are limitations due to the fixed size.

To resolve these limitations of the Type 1 codebook, a Type 2 codebook that transmits feedbacks only for actually transmitted CBG or TBs has been proposed. The Type 2 codebook scheme has an advantage of reducing feedback reporting overhead because the size varies depending on resource allocation.

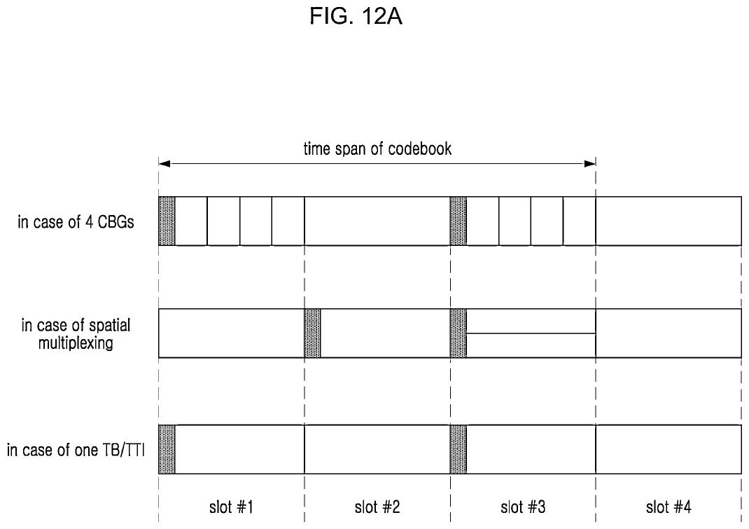

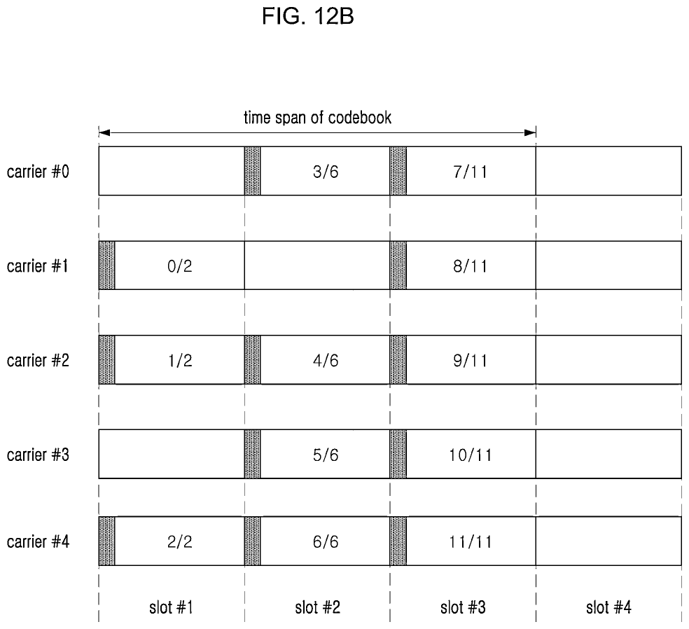

FIG. 12A is a conceptual diagram for describing a case of using a semi-static Type 1 HARQ codebook, and FIG. 12B is a conceptual diagram for describing a case of using a dynamic Type 2 HARQ codebook.

As shown in FIG. 12A, a case with 3 carriers and a time span of 3 slots is illustrated. At the forefront of each slot, a PDCCH including DCI for decoding and demodulating data transmitted in the corresponding slot is exemplified. In FIG. 12A, it is assumed that data is not transmitted in a slot where a PDCCH is not indicated.

FIG. 12A illustrates four slots (i.e. slot #1, slot #2, slot #3, and slot #4), and illustrates a case where a time span of a codebook corresponds to three slots from the slot #1 to slot #3. In FIG. 12A, the top carrier may be a carrier in which four CGBs are transmitted, the middle carrier may be a carrier in which spatial multiplexing is applied, and the bottom carrier may be a carrier in which one TB/TTI is transmitted. Therefore, in FIG. 12A, data is transmitted through a total of three carriers, and data may be transmitted in a different manner for each carrier.

HARQ feedbacks required for the respective carriers illustrated in FIG. 12A will be described.

When four CBGs are transmitted through one carrier, since data (or, packets, information, or signals) corresponding to four different CGBs are transmitted in the slot #1, information (ACKs/NACKs) for four HARQ feedbacks may be transmitted as corresponding to the respective data. This will be described as follows.

When decoding of the first CGB transmitted in the slot #1 is successful, ACK may be transmitted as a HARQ feedback therefor. When decoding of the second CBG is successful, ACK may be transmitted as a HARQ feedback therefor. When decoding of the third CBG fails, NACK may be transmitted as a HARQ feedback therefor. When decoding of the last fourth CBG is successful, ACK may be transmitted as a HARQ feedback therefor. In addition, data may not be transmitted in the slot #2 during the time span of codebook. Therefore, feedback may not need to be transmitted in the slot #2. However, since a semi-static codebook is used and the first carrier comprises four CBGs, the same size of feedbacks need to be transmitted for each slot. Therefore, four pieces of feedback information may be transmitted in the slot #2 as well. However, since the terminal does not receive data in the slot #2, the terminal may transmit only NACKs as HARQ feedbacks. Accordingly, when the base station (or TRP) that has not transmitted data may interpret the feedbacks (i.e. feedbacks for the slot #2) as meaningless information. In addition, if the terminal transmits only NACKs like this, it may help the base station detect that data has not been received at the terminal in that slot. In the slot #3, the terminal may transmit feedback information in the same manner as the slot #1. Therefore, the HARQ feedbacks required in the first carrier requires a total of 12 bits of information.

Next, the case of the second carrier will be described. HARQ feedbacks for the case where data is transmitted through two-layer spatial multiplexing may be transmitted through the second carrier. According to the example of FIG. 12A, the base station may not transmit any data in the slot #1 of the second carrier. Therefore, since the terminal cannot receive data in the slot #1 of the second carrier, it may transmit only NACK as a HARQ feedback. In other words, as described above, although the terminal may not need to feed back any information because data is not transmitted, since a semi-static codebook is used, the terminal may need to feedback only NACKs indicating that data is not received or that decoding fails. Since it is assumed that the second carrier allows two-layer spatial multiplexing, 2 bits of NACKs may be transmitted.

The base station may transmit data that is not spatially multiplexed to the terminal in the slot #2 of the second carrier. Therefore, the terminal may receive only one data that is not spatially multiplexed in the slot #2. As a result, the terminal may transmit 2 bits including one bit indicating ACK/NACK corresponding to a decoding result of the received one data and the other bit representing that other data has not been received or NACK indicating a decoding failure.

For the slot #3 of the second carrier, since two different data (or packets, signals, or information) are transmitted through spatial multiplexing, 2 bits are required to indicate ACK/NACKs of the respective data transmitted through spatial multiplexing.

Accordingly, a total of 6 bits of HARQ feedbacks may be transmitted for the second carrier. Lastly, the case of the third carrier will be described. In the third carrier, transmission may be performed in units of one TB or one TTI. When transmission is performed in units of one TB or one TTI as described above, a HARQ feedback with one bit may be transmitted in each slot (e.g. slot #1, slot #2, or slot #3). Since data is transmitted in the slot #1, one bit feedback indicating ACK/NACK may be transmitted, and since there is no data transmitted in the slot #2, one bit feedback indicating NACK may be transmitted. Since data is transmitted in the slot #3, one bit feedback indicating ACK/NACK may be transmitted.

When data is transmitted by applying different schemes to three carriers as described with reference to FIG. 12A, the HARQ feedbacks may require a total of 21 bits of information.

FIG. 12B assumes a case where a time span of codebook is three slots through five carriers (i.e. carrier #0, carrier #1, carrier #2, carrier #3, carrier #4). When using a dynamic HARQ codebook, a downlink assignment index (DAI) used in the LTE standard may be used. In the NR standard, the DAI may be classified into two types. The DAI may be classified into a count DAI (cDAI) and a total DAI (tDAI) which count the number of TBs. tDAI may represent the total number of data transmitted in a specific slot based on the number of carriers, and cDAI may be a carrier order-based indicator indicating whether data is transmitted in the specific slot. They will be described with reference to FIG. 12B.

In FIG. 12B, a time span of codebook is assumed to be three slots as described in FIG. 12A. In addition, in FIG. 12B, as illustrated in FIG. 12A, a PDCCH including DCI for decoding and demodulating data transmitted in a slot is shown at the forefront of the corresponding slot. In FIG. 12B, it is assumed that data is not transmitted in a slot where a PDCCH is not indicated.

In case of the carrier #0, no data is transmitted in the slot #1, data is transmitted in the slot #2, and data is transmitted in the slot #3. In case of the carrier #1, data is transmitted in the slot #1, no data is transmitted in slot #2, and data is transmitted in the slot #3. In case of the carrier 2, data is transmitted in the slots #1 to #3. In case of the carrier #3, no data is transmitted in the slot #1 and data is transmitted in the slots #2 and #3. In case of the carrier #4, data is transmitted in the slots #1 to #3.

In the above-described case, the total number of data transmissions in the first slot, that is, tDAI, may be 3, and the data may be transmitted in the carrier #1, carrier #2, and carrier #4. A form of (cDAI/tDAI) is illustrated in FIG. 12B. cDAIs may be allocated to the respective carriers in the order of ‘carrier #0→carrier #1→carrier #2→carrier #3→carrier #4’, as illustrated in FIG. 12B. In addition, tDAI may be set as a cumulative sum for each slot.

According to these rules, cDAI and tDAI may be set corresponding to carriers in which data is transmitted in the respective slots.

Specifically, (cDAI/tDAI) in the slot #1 of the carrier #1 may be (0/2), (cDAI/tDAI) in the slot #1 of the carrier #2 may be (1/2), and (cDAI/tDAI) in the slot #1 of the carrier #4 may be (2/2). (cDAI/tDAI) in the slot #2 of the carrier #0 may be (3/6), (cDAI/tDAI) in the slot #2 of the carrier #2 may be (4/6), (cDAI/tDAI) in the slot #2 of the carrier #3 may be (5/6), and (cDAI/tDAI) in the slot #2 of the carrier #4 may be (6/6). In the same manner, (cDAI/tDAI) in the slot #3 of the carrier #0 may be (7/11), (cDAI/tDAI) in the slot #3 of the carrier #1 may be (8/11), (cDAI/tDAI) in the slot #3 of the carrier #2 may be (9/11), (cDAI/tDAI) in the slot #3 of the carrier #3 may be (10/11), and (cDAI/tDAI) in the slot #3 of the carrier #4 may be (11/11).

Therefore, when using the dynamic HARQ feedback, the terminal and base station may identify whether data reception failed in a specific carrier of a specific slot based on cDAI/tDAI. In the scheme of FIG. 12B described above, the HARQ report may consist of 12 bits, one for each transport block received during the time span of codebook.

Meanwhile, in the present disclosure described below, methods of providing low latency and alleviating the HARQ stalling problem by transmitting a control signal through an NTN link with a relatively short latency in an NTN-NTN multi-connectivity environment will be described. In particular, according to the present disclosure described below, when a latency difference between two links is significantly large, a gain can occur even without requiring strict synchronization as in the carrier aggregation (CA) scheme.

In the present disclosure, which is to be described in more detail below, first, it may be determined whether NTN-NTN multi-connectivity is possible. Second, it may be determined whether to configure multi-connectivity according to latencies of two NTN links. Third, considering various operation scenarios based on a NTN backhaul configuration, various methods for transmitting HARQ feedback control signals through a link with a smaller latency will be used. In particular, the present disclosure proposes specific implementation methods for transmitting HARQ feedback control signals through a link with a smaller latency and methods for transmitting retransmission data itself through a link with a smaller latency.

### First Exemplary Embodiment: HARQ Feedback Transmission Method Using a Link Having a Smaller Latency

The first exemplary embodiment of the present disclosure provides methods of transmitting a HARQ feedback for a link with a long latency through a link with a small latency in the NTN-NTN multi-connectivity environment configured with bent-pipe satellites. For example, in case of a dual link, it may be possible to reduce latency and alleviate the HARQ stalling phenomenon by transmitting HARQ feedbacks for both links through a link with a small latency.

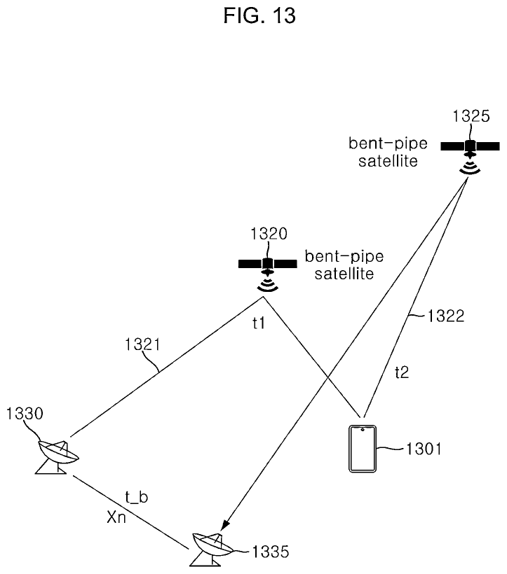

FIG. 13 is a conceptual diagram for describing a configuration of DC between NTN-NTN according to an exemplary embodiment of the present disclosure.

As shown in FIG. 13, a first satellite 1320 in a low orbit, a second satellite 1325 in a high orbit, a first gateway 1330 forming a feeder link with the first satellite 1320, a second gateway 1335 forming a feeder link with the second satellite 1325, and a terminal 1301 are illustrated. The first gateway 1330 and the second gateway 1335 illustrated in FIG. 13 may each include base stations or be connected to base stations. For example, the first gateway 1330 may be connected to or include a first base station (not shown in FIG. 13), and the second gateway 1335 may be connected to or include a second base station (not shown in FIG. 13).

The terminal 1301 may be connected with the first gateway 1330 through the first satellite 1320. In other words, the terminal 1301 may be connected with the first gateway 1330 through a first NTN link 1321. Additionally, the terminal 1301 may be connected with the second gateway 1335 through the second satellite 1325. In other words, the terminal 1301 may be connected with the second gateway 1335 through a second NTN link 1322. In this case, since the example of FIG. 13 assumes the DC environment, the first gateway 1330 may have a backhaul link established with the second gateway 1335 through an Xn interface. Accordingly, the terminal 1301 may perform uplink and/or downlink communication through the first NTN link 1321. At the same time, the terminal 1301 may perform uplink and/or downlink communication through the second NTN link 1322.

The first satellite 1320 and the second satellite 1325 in FIG. 13 may be bent-pipe satellites. The bent-pipe satellite may be a transparent satellite described above, and may only perform a role of amplifying and relaying signals. That is, control on HARQ feedback-related operations described below may be performed by the first gateway 1330 and/or the second gateway 1335, or may be performed by the base station (not shown in FIG. 13) connected with the first gateway 1330 and/or the base station (not shown in FIG. 13) connected with the second gateway 1335.

In order to describe a latency of each link connected to the terminal 1301 in the DC environment, time values may be assumed as follows. First, a latency of a signal transmitted through the first NTN link 1321 may be assumed to be t1. In other words, the latency t1 may be a latency from the terminal 1301 to the first gateway 1330 through the first satellite 1320, or a latency from the terminal 1301 to the first satellite 1320 connected with the first gateway 1330 through the first satellite 1320 and the first gateway 1330.

In addition, a latency of a signal transmitted through the second NTN link 1322 may be assumed to be t2. In other words, the latency t12 may be a latency from the terminal 1301 to the second gateway 1335 through the second satellite 1325, or a latency from the terminal 1301 to the second satellite 1325 connected with the second gateway 1335 through the second satellite 1325 and the second gateway 1335.

As illustrated in the drawing, the second NTN link 1322 through the second satellite 1325 may be a link that takes a longer time than the first NTN link 1321 through the first satellite 1320. Here, even if the first satellite 1320 and the second satellite 1325 are different satellites in the same Earth orbit path, a case may occur that a distance from the terminal 1301 to the first satellite 1320 is shorter than a distance from the terminal 1301 to the second satellite 1325. However, in the following description, for convenience of description, it is assumed that the first satellite 1320 and the second satellite 1325 are satellites with different Earth orbit paths.

In addition, in the DC environment, it may be assumed that the first gateway 1330 and the second gateway 1335 may be connected through a backhaul using the Xn interface, and that a latency of t_b exists for the backhaul. In this case, t_b may vary depending on whether the backhaul is an ideal backhaul or a non-ideal backhaul. In addition, in case of the DC environment, the backhaul link is generally a non-ideal backhaul, and thus in the present disclosure, it is assumed that the backhaul link is a non-ideal backhaul. Therefore, the latency t_b between the first gateway 1330 and the second gateway 1335 may be a fixed value.

In case of the NTN-NTN multi-connectivity, t_b may be a significantly smaller value than t1 and t2, and may be a fixed value. On the other hand, t1 and t2 may change continuously according to the movement of the satellites 1320 and 1325.

The altitude of the satellite 1320, that is, the distance from the terminal, may vary depending on a type of the satellite. Table 7 below describes such the variation by taking GEO and LEO satellites as examples.

When each of the GEO and LEO satellites shown in Table 7 is a bent-pipe satellite, a link of ‘ground station-satellite-terminal’ may be established, and thus the latency corresponding to approximately twice that of the link between the satellite and the terminal may be considered to occur.

TABLE 7

| | GEO | LEO |
|---|---|---|
| Altitude | 35,786 km | 600 km |
| Maximum beam diameter | 3,500 km | 1,000 km |
| Minimum elevation angle | 10° | 10° |
| Maximum RTT | 541.46 ms (scenario A) | 25.77 mc (scenario C) |

According to the present disclosure, when operating in the NTN-NTN DC scheme, a HARQ feedback for a long link may be transmitted through a short link instead of the long link.

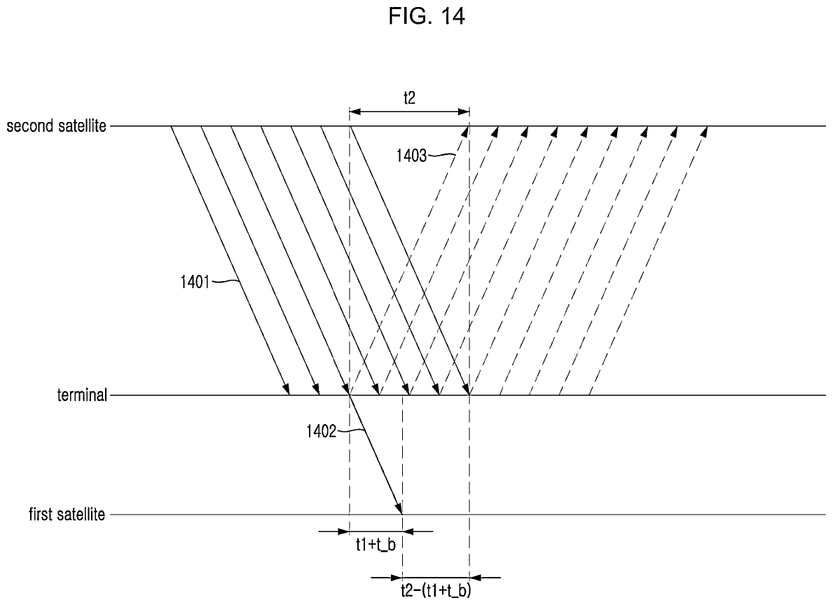

FIG. 14 is a conceptual diagram for describing a HARQ feedback timing of a terminal in an NTN-NTN multi-connectivity environment according to an exemplary embodiment of the present disclosure.

As shown in FIG. 14, a terminal, a first satellite, and a second satellite are illustrated. In FIG. 14, the first satellite may refer to a satellite in a low orbit, and the second satellite may be a satellite in a high orbit, as described in FIG. 13.

The second satellite may transmit data to the terminal through a downlink (e.g. PDSCH). In FIG. 14, the case where data is transmitted from the second satellite through a PDSCH is indicated by a reference numeral 1401. The terminal may demodulate and decode the data received from the second satellite through the PDSCH, and may determine a response (e.g. ACK or NACK) depending on a decoding result. The response may be fed back to the second satellite's gateway based on a semi-static codebook or dynamic codebook described above.

Basically, when the terminal provides a HARQ feedback for the data received from the second satellite, the HARQ feedback may be transmitted to the second satellite as indicated by a reference numeral 1403. Therefore, a latency in transmitting the HARQ feedback may correspond to t2, as described in FIG. 13.

In the first exemplary embodiment of the present disclosure, the terminal in the first satellite-second satellite DC state may transmit the HARQ feedback for the data received from the second satellite to the first satellite as indicated by a reference numeral 1402. When the terminal in the first satellite-second satellite DC state transmits the HARQ feedback for the data received from the second satellite to the first satellite, a latency of (t1+t_b) may occur as illustrated in FIG. 14. Describing this referring back FIG. 13, the terminal 1301 may transmit the HARQ feedback for the second satellite 1325 to the first satellite 1320. In this case, the latency may become t1. In addition, when the base station 1310 receives the HARQ feedback for the second satellite 1325 from the terminal 1301, the base station 1310 may need to deliver the HARQ feedback to the second gateway 1335. Since the latency between the first gateway 1330 and the second gateway 1335 is t_b, if the terminal 1301 transmits the HARQ feedback for the second satellite 1325 through the first satellite 1320, the latency may be reduced by ‘t2−(t1+t_b)’.

Describing this in more detail with reference to FIGS. 13 and 14, when the second gateway 1335 receives a feedback corresponding to a HARQ process 1 of a PDSCH from the terminal 1301 through the second satellite 1325, the second gateway 1335 may receive the feedback after being delayed by a time of t2. On the other hand, when the second gateway 1335 receives the feedback corresponding to the HARQ process 1 of the PDSCH from the terminal 1301 through the first satellite 1320 and the first gateway 1330, the second gateway 1335 may receive the feedback after being delayed by a time of (t1+t_b).

As previously described in FIG. 13, (t1+t_b) may be a smaller value than the t2, so that the HARQ feedback received through the first satellite 1320 can generate a significant latency gain.

In this case, the following two PUCCH operation methods are possible.

### <Method 1>

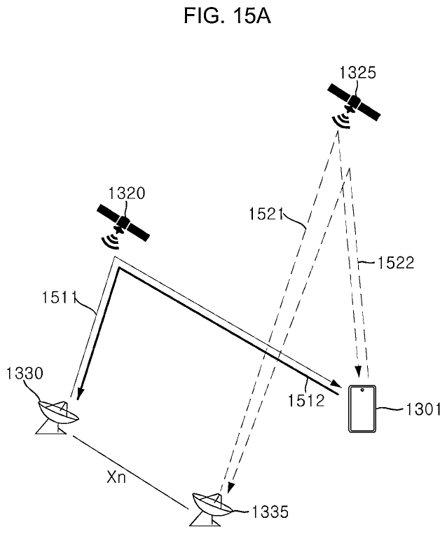

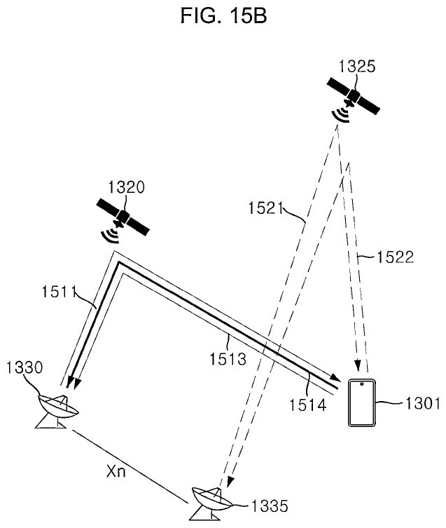

Method 1 according to the first exemplary embodiment of the present disclosure may be a method of extending and using a field of a PUCCH of a link with a smaller latency. This will be described with reference to FIG. 15A.

FIG. 15A is a conceptual diagram illustrating a case of extending and using a PUCCH field of a TN link with a small latency according to the first exemplary embodiment of the present disclosure.

As shown in FIG. 15A, a configuration similar to that previously described in FIG. 13 is illustrated, and the same reference numerals as in FIG. 13 are used for the same components.

As shown in FIG. 15A, the terminal 1301 may be in a state of being connected to the first gateway 1330 through a first NTN link. In addition, the terminal 1301 may be in a state of being connected to the second gateway 1335 through a second NTN link with the second satellite 1325. In this case, since the example of FIG. 15A assumes the DC environment, the first gateway 1330 may have a backhaul link formed through an Xn interface with the second gateway 1335. Accordingly, the terminal 1301 may perform downlink 1511 and/or uplink 1512 communication with the first gateway 1330. At the same time, the terminal 1301 may perform downlink 1521 and/or uplink 1522 communication with the second gateway 1335 through the second satellite 1325.

The first satellite 1320 and the second satellite 1325 in FIG. 15A may be bent-pipe satellites. The bent-pipe satellite may be a transparent satellite described above, and may only perform a role of amplifying and relaying signals. That is, control on HARQ feedback-related operations described below may be performed by the first gateway 1330 and/or a base station (not shown in FIG. 15A) connected to the first gateway 1330.

As previously described in FIG. 13, the second NTN links 1521 and 1522 may have a latency of t2, and the first NTN links 1511 and 1512 may have a latency of t1. In addition, when a signal to be transmitted through the second NTN links 1521 and 1522 is transmitted through the first TN links 1511 and 1512, the latency may become (t1+t_b). In addition, t2 is a very large value compared to (t1+t_b). Therefore, in Method 1 according to the first exemplary embodiment of the present disclosure, HARQ feedback information for data received through the downlink 1521 of the second NTN is transmitted through the uplink 1512 of the first NTN link. To this end, in Method 1 of the first exemplary embodiment of the present disclosure, an additional field may be configured in the uplink 1512 (e.g. PUCCH) of the first NTN link. The HARQ feedback information for the data received through the NTN downlink 1521 may be transmitted by transmitting HARQ codebook information using the additional field of the PUCCH.

In FIG. 15A, the first NTN's uplink 1512 is indicated with a thicker line to describe that not only a feedback signal corresponding to the first NTN's downlink 1511 but also a HARQ feedback corresponding to the second NTN's downlink 1521 are transmitted through the first NTN's uplink 1512.

According to Method 1 of the first exemplary embodiment of the present disclosure, the first NTN's uplink, for example, the PUCCH, may be defined as an extended PUCCH, and the extended PUCCH may have an additional field for transmitting the HARQ feedback corresponding to the second NTN's downlink 1521 in addition the HARQ feedback corresponding to the first NTN's downlink 1511.

### <Method 2>

Method 2 according to the first exemplary embodiment of the present disclosure may be a method of adding a PUCCH to a link with a smaller latency. This will be described with reference to FIG. 15B.

FIG. 15B is a conceptual diagram illustrating a case of using an additional PUCCH of a first NTN according to the first exemplary embodiment of the present disclosure.

As described in FIG. 15A, FIG. 15B also has a similar configuration to that of FIG. 13, and the same reference numerals as in FIG. 13 are used for the same components.

As shown in FIG. 15B, the terminal 1301 may be in a state of being connected to the first gateway 1330 through a first NTN link. In addition, the terminal 1301 may be in a state of being connected to the second gateway 1335 through a second NTN link with the second satellite 1325. In this case, since the example of FIG. 15B assumes the DC environment, the first gateway 1330 may have a backhaul link formed through an Xn interface with the second gateway 1335. Accordingly, the terminal 1301 may perform downlink 1511 and/or uplink 1513 communication with the first gateway 1330. At the same time, the terminal 1301 may perform downlink 1521 and/or uplink 1522 communication with the second gateway 1335 through the second satellite 1325.

The first satellite 1320 and the second satellite 1325 in FIG. 15B may be bent-pipe satellites. The bent-pipe satellite may be a transparent satellite described above, and may only perform a role of amplifying and relaying signals. That is, control on HARQ feedback-related operations described below may be performed by the first gateway 1330 and/or a base station (not shown in FIG. 15B) connected to the first gateway 1330.

As previously described in FIG. 13, the second NTN links 1521 and 1522 have a latency of t2, and the first NTN links 1511 and 1512 may have a latency of t1. When a signal to be transmitted through the second NTN links 1521 and 1522 is transmitted through the first TN links 1511 and 1512, the latency may become (t1+t_b). In addition, t2 is a very large value compared to (t1+t_b). Therefore, in Method 2 according to the first exemplary embodiment of the present disclosure, HARQ feedback information for data received through the second NTN's downlink 1521 may be transmitted through an additional uplink 1514 of the first NTN link. To this end, in Method 2 of the first exemplary embodiment of the present disclosure, a HARQ feedback for data received through the second NTN's downlink 1521 may be transmitted through the additional uplink 1514 (e.g. second PUCCH, PUCCH2) of the first NTN link. FIG. 15B illustrates uplinks for transmitting a feedback signal corresponding to the first NTN's downlink 1511 and a feedback signal corresponding to the second NTN's downlink 1521. Specifically, FIG. 15B illustrates a first PUCCH 1513 for transmitting the feedback signal corresponding to the first NTN's downlink 1511 and a second PUCCH 1514 transmitting a feedback signal corresponding to the second NTN's downlink 1521. In addition, in order to distinguish the additional uplink 1514, the additional uplink 1514 is indicated with a thicker line than the first NTN's uplink 1512.

According to Method 2 of the first exemplary embodiment of the present disclosure, the first NTN having a short link may have the two different uplinks 1513 and 1514, the first uplink 1513 may be an uplink corresponding to the first NTN, and the additional uplink which is the second uplink 1514 may be an uplink for transmitting the HARQ feedback corresponding to the data received through the second NTN's downlink 1521.

On the other hand, control information to be transmitted through the PUCCH(s) in Method 1 and Method 2 described in FIGS. 15A and 15B may be transmitted through PUSCH(s). In addition, in Method 1 and Method 2, it is necessary to deliver the HARQ feedback from the TN base station to the NTN base station through the Xn interface.

The operations in the NTN-NTN DC environment according to the first exemplary embodiment described above may be as follows.

Either the first gateway 1330 or the second gateway 1335 may operate as an MN. In exemplary embodiments below, description will be made assuming the first gateway 1330 with a shorter path as an MN. Additionally, in the following description, a subject of operations will be described as the first gateway 1330. However, actual operations may be performed at the first base station connected to the first gateway 1330.

1) The first gateway 1330 may determine whether multi-connectivity with two satellites is possible. This means that the terminal 1301 needs to have the capability to receive services from the two satellites, and the terminal 1301 needs to be within service coverages of both of the two satellites. The first gateway 1330 may determine whether a service through the two satellites is available, and then transmit data to the terminal 1301 if the DC with the two satellites is possible. Whether the service is available may be determined by the network based on the terminal's location information or based on the terminal's measurement report and UE capability information.

2) In a typical TN, a difference in HARQ feedback timings for two links is not large. However, since a difference in transmission latency between the two links is large in the NTN multi-connectivity environment, additional considerations different from those for the TN environment are required. To this end, the MN according to the present disclosure may determine whether to apply multi-connectivity as follows. As an example, it may be determined whether a sum of the latency t1 of the first NTN link, which is a link between the first satellite and the terminal link, and the latency t_b of the Xn interface is smaller than the latency t2 of the second NTN link, which is a link between the second satellite and the terminal. That is, the latency t2 of the HARQ feedback through the second NTN link, which is the link between the terminal and the second satellite, may be compared with the latency t1+t_b of the HARQ feedback through the link of ‘terminal-first satellite-Xn’. Only when (t1+t_b) is smaller than (t2-margin), the HARQ feedback scheme utilizing the first NTN link, which is a short link, may be applied. Here, the margin may be preconfigured, may be a value predefined in the technical specification, or may be given through higher layer signaling. For this purpose, latency values for the links of the SN may be delivered from the SN to the MN through RRC signaling.

3) If Koffset previously described in FIG. 11B is simply given as RTD, the HARQ feedback timing for the first satellite 1330 may be (2*t1+K1), and the HARQ feedback timing for the second satellite 1335 may be (2*t2+K1). In this case, if a HARQ feedback for the second satellite 1335 with a long link is transmitted through a short link, the HARQ feedback timing may become (t2+t1+t_b+K1). Accordingly, when transmitting, through the short link, a HARQ feedback for data transmission through the long link, a newly calculated HARQ feedback timing value may be delivered from the base station having the short link (i.e. base station connected to the first gateway 1330) to the base station having the long link (i.e. base station connected to the second gateway 1335).

In case of Method 2 according to the first exemplary embodiment of the present disclosure, a first PUCCH corresponding to data transmitted through the first satellite 1320 and a second PUCCH corresponding to data transmitted through the second satellite 1325 may be transmitted independently through the first satellite 1320. Therefore, since the first PUCCH and the second PUCCH independently deliver the HARQ feedbacks for data transmissions of the respective links, correction of HARQ timings therefor is required.

In addition, in case of Method 1 according to the first exemplary embodiment of the present disclosure, since HARQ feedbacks for data transmitted through the first satellite 1330 and data transmitted through the second satellite 1330 are jointly transmitted, a HARQ process identifier (ID) for each link within a time span of codebook may be indicated in addition to HARQ timing information.

In the multi-connectivity environment according to the first exemplary embodiment described above, the base station having a short link may always be maintained as the MN and the base station having a long link may always be maintained as the SN. In other words, they may be operated by configuring a short link NTN base station as the MN and a long link NTN base station as the SN. To this end, if the terminal first establishes an RRC connection with the NTN base station having a long link, the NTN base station having a short link may be changed to the MN through methods below.

First, a method of performing a handover from the second NTN base station having a long link to the first NTN base station having a short link, changing the first NTN base station to the MN, and then adding the second NTN base station as the SN may be used.

Second, a method of adding the first NTN base station having a short link as the SN and then changing the MN and SN through the inter-MN handover and SN change procedures described with reference to FIGS. 9A and 9B may be used.

In the multi-connectivity environment, due to the movement of satellites, the MN, which was initially the SgNB, may be changed to have a latency closer to that of the LgNB, or may be changed to have a long link. If the difference in latency with the LgNB becomes equal to or smaller than a preset level, the proposed method according to the present disclosure may be disabled. In addition, in a situation where the existing SgNB needs to be changed to LgNB and the existing LgNB needs to be changed to SgNB, the inter-MN handover and SN change operations described above in FIGS. 9A and 9B may be performed. In this case, since such SgNB and LgNB changes are made in the RRC connected state, they may be performed through periodic latency value reporting based on the assumption that the base station knows the latencies of the respective satellites.

In the multi-connectivity environment, the MN and SN may be configured through the terminal's initial access procedure. During this procedure, the terminal may select the best cell based on received signal strengths. In general, the longer the latency, the longer the transmission path and the greater the path loss. Therefore, an MN selected based on predicted path loss is likely to become a short link base station. If the selected MN does not have a short link, it may be changed to an MN with a short link through the MN/SN change procedure in the RRC connected state.

As an alternative method, the terminal may first access a satellite with the smallest latency based on timing information in a Msg2 random access response (RAR) through a random access procedure with each candidate satellite, and make that satellite the MN. This method may increase terminal complexity and delay because the process of obtaining Msg2 through the initial random access procedure needs to be performed for all candidate satellites.

In addition, in the multi-connectivity environment according to the first exemplary embodiment of the present disclosure described above, the base station having a short link may not always operate as the MN. In this case, there is no need for the procedure for always maintaining the base station having a short link as the MN. However, in order to support the third exemplary embodiment described below, since the base station having the short link (i.e. short link gNB, SgNB) needs to have data of the base station having the long link (i.e. long link gNB, LgNB), if the SgNB is not the MN, PDCP split functions cannot be applied, and only PDCP duplication functions can be applied.

### Second Exemplary Embodiment: Method for Transmitting Some HARQ Feedbacks Through a Link with a Smaller Latency

The HARQ stalling phenomenon on a long link with a large transmission latency can be solved by increasing the number of HARQ processes, but as the number of HARQ processes increases, a problem of increased system complexity and increased latency may be difficult to solve. Further, when using a transmission method without HARQ feedback on a link having a large transmission latency, since data needs to be transmitted regardless of a channel state, repeated transmission is required to secure high reliability of 5G communication. Such the repeated transmission inevitably causes resource wastes.

In addition, the method of transmitting all HARQ feedbacks through a short link with a smaller latency, as in the first exemplary embodiment described above, may cause a problem of increasing the burden on the short link. Accordingly, the above-mentioned problems can be solved by transmitting only a predetermined number (e.g. X) of HARQ feedback through the short link. In this case, the value of the predetermined number (e.g. X) may be determined considering the following matters.

1) The value of X may be determined according to a relative ratio of the long link latency to the short link latency.

2) The value of X may be determined by parameters such as satellite altitude and satellite speed.

For example, when a latency of a long link is significantly greater than that of a short link, X may become relatively large, resulting in a greater number of HARQ feedbacks being transmitted through the short link.”

In this case, the base station (e.g. MN or SN) may distinguish HARQ process(es) that transmit HARQ feedback information using the short link among all HARQ process IDs, and indicate them through RRC signaling. That is, the base station may select HARQ processes for which HARQ feedbacks are transmitted through the long link or short link in response to data received through the long link, and then indicate the selected HARQ processes to the terminal through RRC signaling.

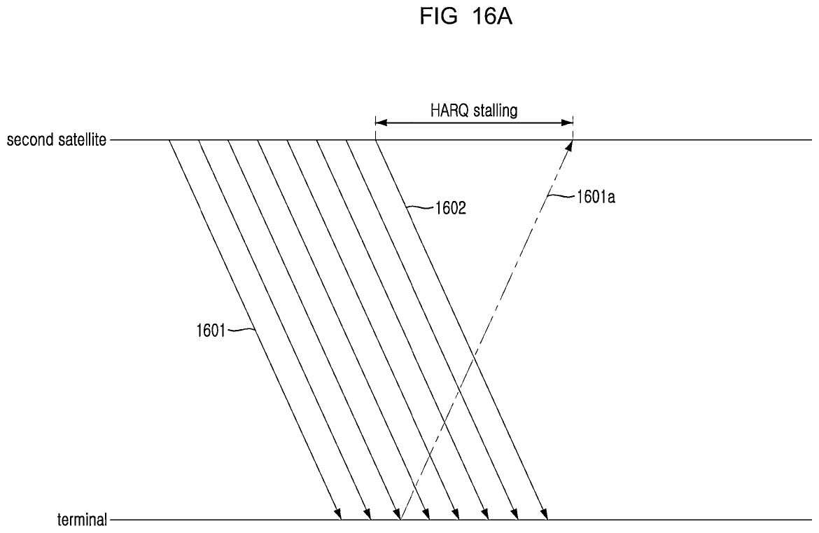

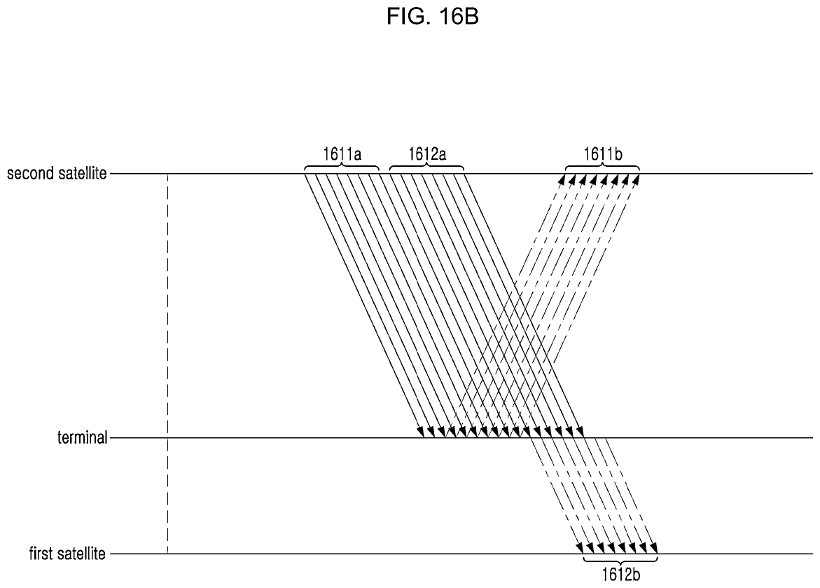

FIG. 16A is a timing diagram for describing a HARQ stalling phenomenon based on reception of PDSCHs from a second satellite of a long link to a terminal and HARQ feedbacks therefor.

As shown in FIG. 16A, the second satellite may transmit data to the terminal through PDSCHs based on HARQ processes. The second satellite may transmit PDSCHs eight times to the terminal through the long link, based on HARQ processes. Since the eight HARQ processes are configured, the base station having the long link may need to receive at least one HARQ feedback while transmitting the PDSCHs eight times to the terminal in order to transmit a new PDSCH.

However, due to the latency of the long link and processing capability of the terminal, a HARQ feedback may not be received until all PDSCHs based on the HARQ processes are transmitted.

Specifically, the base station connected to the second satellite or the second satellite may not be able to receive a HARQ feedback 1601a corresponding to data 1601 initially transmitted through the long link until transmission of last data 1602 based on a HARQ process is performed. Therefore, as illustrated in FIG. 16A, a period in which the base station connected to the second satellite cannot transmit the next data to the terminal may occur. In other words, a HARQ stalling phenomenon may occur.

In the second exemplary embodiment of the present disclosure, as a method for resolving the above-described problem, a feedback path based on a HARQ process may be configured differently. This will be described with reference to FIG. 16B.

FIG. 16B is a timing diagram for describing HARQ feedbacks based on HARQ processes in an NTN-NTN DC environment according to the second exemplary embodiment of the present disclosure.

As shown in FIG. 16B, it is assumed that eight HARQ processes are used as in FIG. 16A.

According to the second exemplary embodiment of the present disclosure, the second base station of the second satellite may transmit data to the terminal based on eight HARQ processes (1611a). The terminal may receive the data 1611a through the second satellite, demodulate and decode the data, and determine ACK or NACK as a HARQ response corresponding to whether a decoding result is successful. Then, the terminal may transmit the determined ACKs/NACKs as HARQ feedbacks to the second base station through the second satellite (1611b).

In addition, the second base station of the second satellite may transmit the next data based on the eight HARQ processes (1612a). In this case, the second base station of the second satellite may configure a HARQ feedback for the even-numbered HARQ process to be transmitted to the first base station of the first satellite, by using an RRC message, or the like. The terminal may receive the data 1612a through the second satellite, demodulate and decode the data, and determine ACK or NACK as a HARQ response corresponding to whether a decoding result is successful. Then, the terminal may transmit the ACKs/NACKs, which are determined based on whether the decoding is successful or not, to the first base station as HARQ feedbacks through the first satellite, based on the RRC signaling (1612b).

As described above, the terminal may respond, through the long link, to data received first from the second satellite based on a HARQ process, and respond, through the short link, to data received the second time from the second satellite based on the same HARQ process. In other words, the terminal may transmit, through the second satellite, HARQ feedbacks corresponding to data received based on the odd-numbered HARQ processes (e.g. first, third, and fifth HARQ processes), and transmit, through the first satellite, HARQ feedbacks corresponding to data received based on the even-numbered HARQ processes (e.g. second, fourth, and sixth HARQ processes).

In the second exemplary embodiment of the present disclosure, in order to determine a HARQ feedback to be transmitted through the long link and a HARQ feedback to be transmitted through the short link based on whether a corresponding HARQ process is odd-numbered or even-numbered, a link identification bit may be added to downlink control information (DCI) in addition to a HARQ process identifier (HARQ process ID). For example, the DCI may be configured to include one bit of additional information indicating the short link or long link. This DCI may be referred to as an extended DCI in the present disclosure.

In addition, since the extended DCI according to the present disclosure is determined for data of the long link, it may be determined at the second base station (or second gateway) and transmitted through a PDCCH transmitted together with a corresponding PDSCH.

Through the operation according to the second exemplary embodiment of the present disclosure described above, the HARQ starling phenomenon can be alleviated and a final HARQ feedback reception latency can be reduced. Further, the two methods described in the first exemplary embodiment of the present disclosure may be used as a method of transmitting the HARQ feedback information for the long link through a control channel of the short link.

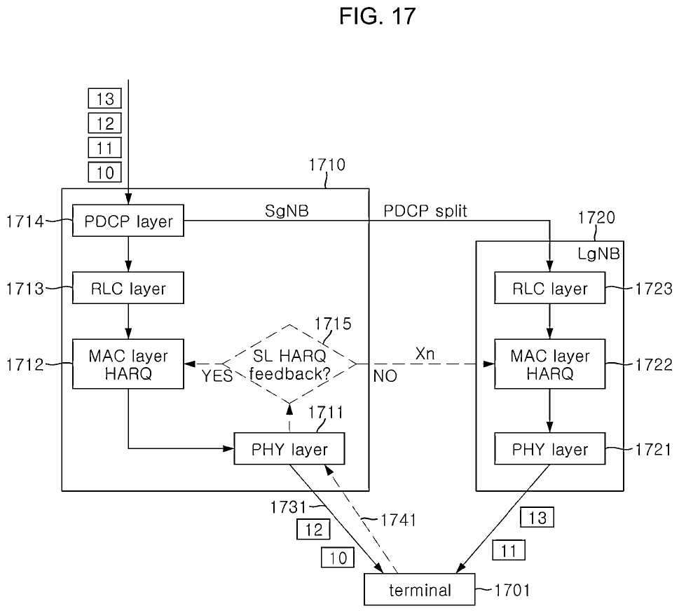

FIG. 17 is a conceptual diagram illustrating internal hierarchical configuration and connection configuration of base stations according to the second exemplary embodiment of the present disclosure.

As shown in FIG. 17, a base station (SgNB) 1710 with a short link, a base station (LgNB) 1720 with a long link, and a terminal 1701 are illustrated. The SgNB 1710 may be a base station connected with the first satellite and the first gateway, and the LgNB 1720 may be a base station connected with the first satellite and the second gateway, as described in FIGS. 16A and 16B. In FIG. 17, it may be assumed that the SgNB 1710 is an MN and the LgNB 1720 is an SN, as described above.

The SgNB 1710 may include the layers described in FIG. 8. For example, the SgNB 1710 may include a physical layer 1711, a MAC layer 1712, an RLC layer 1713, and a PDCP layer 1714. Additionally, the SgNB 1710 illustrated in FIG. 17 may further include a determiner 1715 according to the second exemplary embodiment of the present disclosure. According to the present disclosure, the determiner 1715 may be included in the MAC layer 1712. According to another exemplary embodiment of the present disclosure, the determiner 1715 may be included in the physical layer 1711. According to yet another exemplary embodiment of the present disclosure, the determiner 1715 may be a separate component located between the physical layer 1711 and the MAC layer 1712.

In addition, FIG. 17 illustrates a case where data blocks 10, 11, 12, and 13 to be transmitted to the terminal are delivered to the SgNB 1710. When the SgNB 1710 receives the data blocks 10, 11, 12, and 13, the PDCP layer 1714 may split the data blocks into data block(s) to be transmitted by the SgNB 1710 and data block(s) to be transmitted by the LgNB 1720. This may correspond to the PDCP split operation described previously. In FIG. 17, it is assumed that the SgNB 1710 transmits the data blocks 10 and 12 and the LgNB 1720 transmits the data blocks 11 and 13, as described in FIG. 8. Accordingly, the PDCP layer 1714 of the SgNB 1710 may deliver the data blocks 10 and 12 to be transmitted by the SgNB 1710 to the RLC layer 1713, and deliver the data blocks 11 and 13 to be transmitted by the LgNB 1720 to the RLC layer 1723 of the LgNB 1730.

The respective RLC layers 1713 and 1723 of the SgNB 1710 and LgNB 1720 may perform data classification and/or reordering on the data blocks provided from the PDCP layer 1714, and deliver them to the respective lower MAC layers 1712 and 1722. The respective MAC layers 1712 and 1722 of the SgNB 1710 and the LgNB 1720 may perform HARQ control, multiplexing/demultiplexing, and logical channel priority determination for the classified and/or reordered data blocks, and deliver them to the corresponding physical layers 1711 and 1721. The respective physical layers 1711 and 1721 may transmit the data blocks 10, 11, 12, and 13 to the terminal 1701 through predetermined radio channels (e.g. PDSCHs or PDSCHs) by up-converting the data blocks received from the upper layers into signals in a transmission band, and amplifying the signals in the transmission band.

Based on the method described above, the SgNB 1710 may transmit the data blocks 10 and 12 to the terminal 1701, and the LgNB 1720 may transmit the data blocks 11 and 13 to the terminal 1701. In FIG. 17, the radio channel transmitted by the SgNB 1710 to the terminal 1701 is illustrated by a reference numeral 1731, and the radio channel transmitted by the LgNB 1720 to the terminal 1701 is illustrated by a reference numeral 1732.

Since the SgNB 1710 is a base station with a short link, a latency in transmitting the data block to the terminal 1701 through a predetermined radio channel (e.g. PDSCH/PDCCH 1731) may be short, but since the LgNB 1720 is a base station with a long link, a latency in transmitting the data block to the terminal 1701 through a predetermined radio channel (e.g. PDSCH/PDCCH 1732) may be long.

On the other hand, the terminal 1701 may demodulate and decode the data blocks received from the SgNB 1710 and the LgNB 1720, and determine responses (e.g. ACK/NACK) corresponding to demodulation/decoding results. The terminal 1701 may transmit the responses corresponding to the demodulation/decoding results to the SgNB 1710 and/or LgNB 1720 as HARQ feedbacks.

In this case, according to the second exemplary embodiment of the present disclosure, as previously described in FIGS. 16A and 16B, the terminal 1701 may transmit the HARQ feedback for the data received from the LgNB 1720 having a long link to the LgNB 1720 or the SgNB 1710 alternately according to the odd-numbered or even-numbered HARQ process. For example, the terminal 1701 may transmit an odd-numbered HARQ feedback to the LgNB 1720, and transmit an even-numbered HARQ feedback to the SgNB 1710, on a HARQ process basis.

Accordingly, the SgNB 1710 may output HARQ feedback information received from the physical layer 1711 to the determiner 1715 without delivering it to the MAC layer 1712. The determiner 1715 may identify whether the HARQ feedback received from the physical layer 1711 is a HARQ feedback for data received through the short link (i.e. SL HARQ feedback). This identification may be made using the first exemplary embodiment. For example, when the HARQ feedback is received through an extended PUCCH as in Method 1 of the first exemplary embodiment, the HARQ feedback information in the extended field may be a HARQ feedback for data received through the long link. In addition, when the HARQ feedback is received through the additional second PUCCH as in Method 2 of the first exemplary embodiment, the HARQ feedback information received through the second PUCCH may be a HARQ feedback for data received through the long link.

Based on the above-described identification, the determiner 1715 may provide the feedback information received from the physical layer 1711 to the MAC layer 1712 of the SgNB 1710 in the case of SL HARQ feedback. On the other hand, if it is not a SL HARQ feedback, that is, if it is a HARQ feedback for data received through the long link (i.e. LL HARQ feedback), the determiner 1715 may provide the feedback information received from the physical layer 1711 to the MAC layer 1722 of the LgNB 1720. In this case, the feedback information transmitted by the determiner 1715 to the MAC layer 1722 of the LgNB 1720 may be transmitted using the Xn interface that provides connection between the base stations.

### Third Exemplary Embodiment: Method for Retransmitting Data Through a Short Link in Case of HARQ Negative Response (NACK)

Retransmission through a link with a large transmission latency has a problem of further increasing the latency. Therefore, in the third exemplary embodiment of the present disclosure, when retransmission is required due to a HARQ negative response (NACK), the problem in the latency can be alleviated by performing the retransmission through a short link with a low latency. In addition, in order to finally receive data blocks in order, the base station needs to store received data blocks until retransmission of all data blocks is successful. Therefore, when applying the third exemplary embodiment of the present disclosure, an effect can be expected that reduces a capacity of memory for storing the received data blocks until successful completion of retransmissions from the base station.

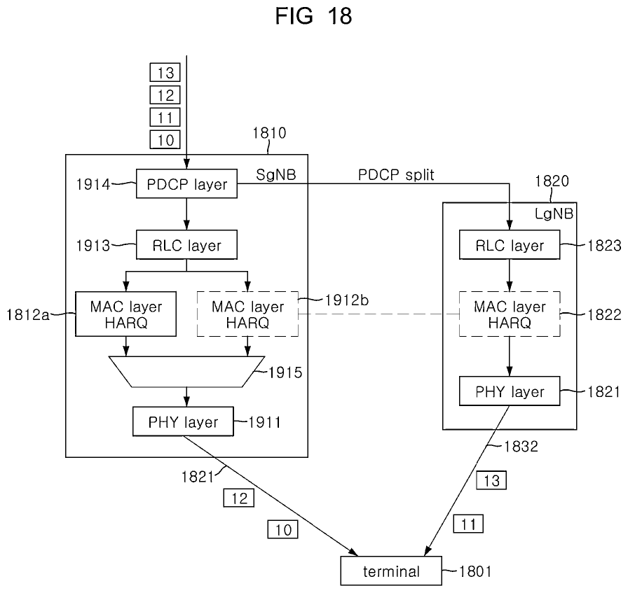

FIG. 18 is a conceptual diagram for describing internal hierarchical configuration and connection configuration of base stations according to the third exemplary embodiment of the present disclosure.

As shown in FIG. 18, a base station (SgNB) 1810 having a short link, a base station (LgNB) 1820 having a long link, and a terminal 1801 are illustrated. The SgNB 1810 may be a base station connected with the first satellite having a short link, and the LgNB 1920 may be a base station connected with the second satellite having a long link. In FIG. 18, it is assumed that the SgNB 1810 is an MN and the LgNB 1820 is an SN, as described above.

The SgNB 1810 may include the layers described in FIG. 8. For example, the SgNB 1810 may include a physical layer 1811, MAC layers 1812a and 1812b, RLC layer 1813, and PDCP layer 1814. The MAC layers 1812a and 1812b may include the MAC layer 1812a for transmission of TN data blocks and the MAC layer 1812b for transmission of NTN data blocks.

The MAC layer 1812b for transmission of data blocks through the long link may be a duplicate MAC layer identical to the MAC layer 1822 of the LgNB 1820 according to the third exemplary embodiment of the present disclosure. This may be understood in the same form as PDCP duplication described in FIG. 8. For example, the MAC layer 1812b may need to know the same redundancy version (RV) for retransmission of data blocks transmitted from the MAC layer 1822 of the LgNB 1820. Accordingly, the MAC layer 1812b included in the SgNB 1810 may correspond to a duplicate of the MAC layer 1822 of the LgNB 1820.

In addition, since the case of FIG. 18 includes the MAC layers 1812a and 1812b that process different data, the base station may further include a multiplexer 1815 for multiplexing data blocks received from the MAC layers 1812a and 1812b. The multiplexer 1815 may multiplex the data blocks received from the respective MAC layers 1812a and 1812b and deliver them to the physical layer 1811.

In FIG. 18, the MAC layer 1812b included in the SgNB 1810 and the MAC layer 1822 of the LgNB 1820 are indicated with dotted lines, indicating that the MAC layer 1812b included in the SgNB 1810 is a duplication of the MAC layer 1822 of the LgNB 1820. The interconnecting dotted line indicates that the same operations are performed in the both MAC layers.

The LgNB 1820 may also include the layers described in FIG. 8. For example, the LgNB 1820 may include a physical layer 1821, a MAC layer 1822, and an RLC layer 1823. Since basic operations performed by the LgNB 1820 are the same as described in FIG. 8, redundant description will be omitted.

Hereinafter, operations corresponding to the configuration of the base stations according to the third exemplary embodiment of the present disclosure described in FIG. 18 will be described.

FIG. 18 illustrates a case where data blocks 10, 11, 12, and 13 to be transmitted to the terminal 1801 are delivered to the SgNB 1810. In this case, the SgNB 1810 may operate as an MN as described above. When the SgNB 1810, operating as an MN, receives the data blocks 10, 11, 12, and 13, the PDCP layer 1814 may split the data block(s) into data block(s) to be transmitted from the SgNB 1810 and data block(s) to be transmitted from the LgNB 1820. This may correspond to the PDCP split operation described previously.

Unlike the previous exemplary embodiments, the SgNB 1810 according to the third exemplary embodiment of the present disclosure needs to process all PDCP data blocks. That is, even in case of the PDCP split operation, the SgNB 1810 may need to deliver the split data blocks to the LgNB 1820 and process them internally also in the SgNB 1810 at the same time. That is, the SgNB 1810 needs to be able to process all PDCP data blocks. However, if the SgNB 1810 is not an MN, PDCP split between two nodes cannot be applied, and only PDCP duplication can be applied.

In case of initial transmission, in FIG. 18, it is assumed that the SgNB 1810 transmits the data blocks 10 and 12, and the LgNB 1820 transmits the data blocks 11 and 13, as described in FIG. 8. Accordingly, the PDCP layer 1814 of the SgNB 1810 may deliver the data blocks 10 and 12 to be transmitted from the SgNB 1810 to the RLC layer 1813, and deliver the data blocks 11 and 13 to be transmitted from the LgNB 1820 to the RLC layer 1823 of the LgNB 1820. In addition, according to the third exemplary embodiment of the present disclosure, since the LgNB 1820 needs to perform retransmission for the initially transmitted data blocks 11 and 13, the PDCP layer 1814 of the SgNB 1810 may also deliver the data blocks 11 and 13 initially transmitted by the LgNB 1820 to the RLC layer 1813.

The respective RLC layers 1813 and 1823 of the SgNB 1810 and LgNB 1820 may perform data classification and/or reordering on the data blocks provided from the PDCP layer 1814, and deliver them to the respective lower MAC layers 1812 and 1822. In this case, the RLC layer 1813 of the SgNB 1810 may deliver the data blocks 10 and 12 to be transmitted from the SgNB 1810 to the MAC layer 1812a, and deliver the data blocks 11 and 13 initially transmitted by the LgNB 1820 to the MAC layer 1812b.

The respective MAC layers 1812a, 1812b and 1822 of the SgNB 1810 and the LgNB 1820 may perform HARQ control, multiplexing/demultiplexing, and logical channel priority determination for the data blocks classified and/or reordered by the respective RLC layers 1813 and 1823. In this case, since the MAC layer 1812b of the SgNB 1810 needs to be driven only during retransmission of the data transmitted through the long link, it may not output actual data during initial transmission. However, the MAC layer 1812b of the SgNB 1810 may generate the same data as the MAC layer 1822 of the LgNB 1820 for the same MCS and HARQ process as the MAC layer 1822 of the LgNB 1820. In other words, the MAC layer 1812b of the SgNB 1810 may perform a clone HARQ operation of the MAC layer 1822 of the LgNB 1820.

The MAC layers 1812a and 1812b of the SgNB 1810 may deliver data blocks, which are multiplexed by the multiplexer 1815 for multiplexing outputs of the respective MAC layers 1812a and 1812b, to the physical layer 1811, and the MAC layer 1822 of the LgNB 1820 may directly deliver the corresponding data blocks to the physical layer 1821.

The respective physical layers 1811 and 1821 of the SgNB 1810 and the LgNB 1820 may transmit the data blocks 10, 11, 12, and 13 to the terminal 1801 through predetermined radio channels (e.g. PDSCHs or PDSCHs) by up-converting the data blocks received from the upper layers into signals in a transmission band, and amplifying the signals in the transmission band.

In this case, when retransmission of the data block 11 transmitted from the LgNB 1820 to the terminal 1801 is required, the terminal 1801 may transmit HARQ feedback information to the SgNB 1810 based on one of the two methods described in the first exemplary embodiment of the present disclosure. Accordingly, when the SgNB 1810 receives a negative response (NACK) as the HARQ feedback information for the data block 11 transmitted from the LgNB 1820 to the terminal 1801, the MAC layer 1812b of the SgNB 1810 may generate the same retransmission data as in a retransmission operation in the MAC layer 1822 of the LgNB 1820, and deliver the generated retransmission data to the physical layer 1811 through the multiplexer 1815. Accordingly, the physical layer 1811 of the SgNB 1810 may transmit the retransmission data for the data block 11, which was transmitted from the LgNB 1820 to the terminal 1801, to the terminal 1801.

As described above, since retransmission for the data blocks transmitted from the LgNB 1820 to the terminal 1801 is performed in the MAC layer 1812b of the SgNB 1810, the MAC layer 1822 of the LgNB 1820 may generate only encoded bits for an RV in initial transmission.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a first base station, comprising:
transmitting data to a terminal through a first non-terrestrial network (NTN) link with a first satellite connected to a first base station and through a second NTN link with a second satellite connected to a second base station, the terminal being in a dual connectivity (DC) state; and
receiving at least one uplink channel including first hybrid automatic repeat request (HARQ) feedback information corresponding to the data transmitted to the terminal the first NTN link and second HARQ feedback information corresponding to data transmitted to the terminal through the second NTN link.

2. The method according to claim 1, wherein each of the first HARQ feedback information and the second HARQ feedback information includes information indicating acknowledgment (ACK) or negative ACK (NACK) for received data, and the at least one uplink channel includes a first physical uplink control channel (PUCCH1) for transmitting the first HARQ feedback information and a second PUCCH (PUCCH2) for transmitting the second HARQ feedback information.

3. The method according to claim 2, wherein the PUCCH2 is received using only a HARQ process preconfigured through a radio resource control (RRC) message by the second base station.

4. The method according to claim 1, wherein the at least one uplink channel is an extended PUCCH including an additional field for transmitting at least part of the second HARQ feedback information.

5. The method according to claim 4, wherein the additional field of the extended PUCCH includes information indicating ACK or NACK for data received through the second NTN link, and further includes at least one of information on a HARQ timing corresponding to the data received through the second NTN link or a HARQ process identifier (ID) within a time span of a codebook corresponding to the data received through the second NTN link.

6. The method according to claim 1, further comprising:
in response to receiving, from a network, the data to be transmitted to the terminal in the DC state, splitting the data to be transmitted to the terminal into data to be transmitted through the first NTN link and data to be transmitted through the second link; and
delivering the data to be transmitted through the second NTN link to the second base station.

7. The method according to claim 6, further comprising:
identifying a retransmission request corresponding to data transmitted through the first NTN link and/or a retransmission request for data transmitted through the second link, based on the first HARQ feedback information and the second HARQ feedback information; and
in response to identifying that a retransmission corresponding to the data transmitted through the second NTN link is requested, transmitting a retransmission request to the second base station.

8. The method according to claim 6, further comprising:
generating retransmission data using a same scheme as in the second base station of the second NTN link, based on the data transmitted through the second NTN link; and
transmitting the generated retransmission data to the terminal when the second HARQ feedback information requests a retransmission corresponding to the data transmitted through the second NTN link.

9. The method according to claim 8, wherein the retransmission data corresponding to the data transmitted through the second NTN link is generated based on a same redundancy version (RV) and a same modulation and coding scheme (MCS) as the data transmitted through the second NTN link.

10. A method of a terminal, comprising:
establishing dual connectivity (DC) with a second non-terrestrial network (NTN) link of a second satellite connected to a second base station while being connected to a first NTN link of a first satellite connected to a first base station, based on a control message received through the first NTN link;
receiving data through the first NTN link;
receiving data through the second NTN link;
generating first hybrid automatic repeat request (HARQ) feedback information corresponding to the data received through the first NTN link;
generating second HARQ feedback information corresponding to the data received through the second NTN link; and
transmitting the first HARQ feedback information and the second HARQ feedback information through at least one uplink channel of the first NTN link,
wherein a difference between a latency of the second NTN link and a latency of the first NTN link is equal to or greater than a preset value.

11. The method according to claim 10, wherein each of the first HARQ feedback information and the second HARQ feedback information includes information indicating acknowledgment (ACK) or negative ACK (NACK) for received data, and the at least one uplink channel includes a first physical uplink control channel (PUCCH1) for transmitting the first HARQ feedback information and a second PUCCH (PUCCH2) for transmitting the second HARQ feedback information.

12. The method according to claim 11, wherein the PUCCH2 is transmitted using only a HARQ process preconfigured through a radio resource control (RRC) message by the second base station of the second NTN link.

13. The method according to claim 10, wherein the at least one uplink channel is an extended PUCCH including an additional field for transmitting at least part of the second HARQ feedback information.

14. The method according to claim 13, wherein the additional field of the extended PUCCH includes information indicating ACK or NACK for data received through the second NTN link, and further includes at least one of information on a HARQ timing corresponding to the data received through the second NTN link or a HARQ process identifier (ID) within a time span of a codebook corresponding to the data received through the second NTN link.

15. The method according to claim 10, further comprising: in response to the second HARQ feedback information indicating at least one reception failure for received data, receiving retransmission data through the first NTN link.

16. The method according to claim 10, further comprising: in response to the second HARQ feedback information indicating at least one reception failure for received data, receiving retransmission data through the second NTN link.

17. A base station comprising at least one processor, wherein the at least one processor causes to the base station perform:
transmitting data to a terminal through a first non-terrestrial network (NTN) link with a first satellite connected to a first base station and through a second NTN link with a second satellite connected to a second base station, the terminal being in a dual connectivity (DC) state; and
receiving at least one uplink channel including first hybrid automatic repeat request (HARQ) feedback information corresponding to the data transmitted to the terminal the first NTN link and second HARQ feedback information corresponding to data transmitted to the terminal through the second NTN link.

18. The base station according to claim 17, wherein each of the first HARQ feedback information and the second HARQ feedback information includes information indicating acknowledgment (ACK) or negative ACK (NACK) for received data, and the at least one uplink channel includes a first physical uplink control channel (PUCCH1) for transmitting the first HARQ feedback information and a second PUCCH (PUCCH2) for transmitting the second HARQ feedback information.

19. The base station according to claim 17, wherein the at least one uplink channel is an extended PUCCH including an additional field for transmitting at least part of the second HARQ feedback information.

20. The base station according to claim 17, wherein the at least one processor further causes to the base station perform:
in response to receiving, from a network, the data to be transmitted to the terminal in the DC state, splitting the data to be transmitted to the terminal into data to be transmitted through the first NTN link and data to be transmitted through the second link;
delivering the data to be transmitted through the second NTN link to the second base station;
identifying a retransmission request corresponding to data transmitted through the first NTN link and/or a retransmission request for data transmitted through the second link, based on the first HARQ feedback information and the second HARQ feedback information; and
in response to identifying that a retransmission corresponding to the data transmitted through the second NTN link is requested, transmitting a retransmission request to the second base station.
